(19) United States
(12) Patent Application Publication
(10) Pub. No.: US 2001/0005833 A1
(43) Pub. Date: Jun. 28, 2001

(54) Product distribution system and method for providing information to customer in context of such system

(76) Inventors: Jeorge Asami, Tokyo (JP); Kazuki Hirohata, Tokyo (JP); Masaharu Kuribayashi, Tokyo (JP); Tomokazu Takahashi, Tokyo (JP)

Correspondence Address: GALLAGHER & LATHROP, Suite 1111, 601 California Street, San Francisco, CA, 94108-2805, US

(21) Appl. No.: 09/746,943

(22) Filed: Dec. 22, 2000

(30) Foreign Application Priority Data
Dec. 24, 1999 (JP) 367797/99
Sep. 4, 2000 (JP) 267663/00
Feb. 25, 2000 (JP) 049254/00

(51) Int. Cl. G06F 17/60

(52) U.S. Cl. 705/26; 705/27

(57) ABSTRACT

When a customer buys a product at a store or by way of storeless sales system 5 (web server), that product is automatically registered with data management system 4 as an item owned by the customer. Storeless sales system 5, either at regular intervals or on demand, updates resale prices for items owned by the customer within data management system 4 to most-recent values therefor, and displays these on a customer website which can be accessed by customer terminal 7. When a customer at customer terminal 7 views, from that customer website, a catalog page for a product he wishes to purchase, storeless sales system 5 furthermore displays that catalog such that a difference in price between the selling price of the product the customer wishes to purchase and the resale price of an item owned by that customer are calculated thereon. Storeless sales system 5 may moreover target an item for a resale campaign, automatically extract customers who own the targeted item, and automatically send an e-mail message advising them of the resale campaign.

### BACKGROUND

The present invention pertains to a capability permitting viewing of award points on a website in the context of a product sale system and to a capability for use and addition of such points. Furthermore, the present invention relates to a product distribution system for carrying out resale and purchase of products using a computer system and a communications network such as the Internet, and in particular pertains to a capability for linking resale and purchase of used products, as well as resale of used products and selling of new items and so forth.

Art wherein award points are given to customers in correspondence to purchase amounts or the like when customers purchase products or services and wherein special discounts, prizes, and the like are provided to customers in correspondence to accumulated award points is known in the context of sales systems employing computers.

Award points of customers are normally managed by means of a customer database internal to the sales system or by recording such points on a membership card serving as proof that the award points have indeed been accumulated by the customer who is the bearer of the card. When the customer hands the membership card to a store attendant at the time a purchase is made, the store attendant places that membership card on a store sales system terminal, as a result of which the previously earned award points stored in the customer database are displayed at the store terminal. Depending on the wish of the customer, the sales system may either use those previously earned award points (e.g., for award of a discount in correspondence thereto) or may add the newly earned award points to the previously earned award points without using the previously earned award points.

However, the customer cannot freely find out on his own how many award points he has accumulated at any given time. Furthermore, the customer cannot make free use of the award points he has accumulated without making such a request to the store attendant.

Moreover, a customer may sometimes want to know the resale price of a used item in his possession. In such a case, the customer must go to a used goods shop and inquire about resale price or telephone the used goods shop and inquire about resale price.

Furthermore, since such a resale price will typically vary with passage of time, the customer will have no way of knowing when the resale price is fluctuating. For this reason, when the customer does eventually resell the item, the resale price may well have fallen to an extremely low level. In order to avoid this, the customer must make regular inquiries regarding resale price, but because he would have to go to or telephone a used goods shop on each such occasion, this would be troublesome. Resale price moreover varies depending on the condition of a used item. For this reason, when the customer does eventually resell the item and an accurate assessment of value is made, the customer may be disappointed to find that the resale price has fallen considerably below the amount that had been expected. Such problem is only compounded when there are a large number of such used items that the customer wishes to resell.

Furthermore, it often happens that a customer will want to apply, to purchase of a new item, funds the customer has obtained as a result of sale of a used item to a used goods shop. In such a case, the customer must calculate in his own mind, given the resale price of the used item and the selling price of the new item, just how much additional money from his own funds he will have to contribute before he can buy the new item which he desires. In a case where there are a number of candidate used items which the customer is considering selling and a number of candidate new items which the customer is considering buying, it is extremely difficult for the customer to perform the foregoing calculation in his own mind and make an accurate determination of what he should sell and what he should buy.

In addition, a large number of shops employ an award point system such that award points toward receipt of discounts, bonuses, or the like are given to respective customers in correspondence to the value of transactions conducted to date. Because with such shops there is the matter of award points to further complicate the aforementioned problem related to used item resale price, it becomes all the more difficult for the customer to carry out an accurate financial analysis of the situation.

When a customer purchases a new item, this new item becomes a used item from that day forward and is liable to treatment as an object for resale as a used item. A fair number of customers purchase new items with the intention of using that item for a certain period, after which they plan to sell it to a used goods shop while it is still popular as a used item. However, it is difficult for the customer to determine what an appropriate period might be within which an item should be sold as a used item in order to obtain favorable terms.

Accordingly, it is an object of the present invention to make it possible for a customer to freely determine the status of his award points in the context of a sales system.

It is another object of the present invention to permit a customer to make free use of his award points in the context of a sales system without having to make such a request to a store attendant.

It is yet another object of the present invention to permit a customer to easily learn of a resale price for a used item in the context of a product distribution system.

It is another object of the present invention to permit a customer to learn of an accurate resale price.

It is yet another object of the present invention to permit a customer to easily take into consideration a resale price for a used item when contemplating purchase of a new item.

It is moreover yet another object of the present invention to permit a customer to also easily take award points into consideration when contemplating purchase of a new item.

It is moreover still another object of the present invention to permit a customer to accurately determine an appropriate period within which a used item should be sold to a used goods shop.

It is moreover yet another object of the present invention to permit a customer who wishes to purchase a used item to purchase such used item at a price as close as possible to his asking price.

### SUMMARY

The present invention pertains to a capability permitting viewing of award points on a website in the context of a product sale system and to a capability for use and addition of such points. Furthermore, the present invention relates to a product distribution system for carrying out resale and purchase of products using a computer system and a communications network such as the Internet, and in particular pertains to a capability for linking resale and purchase of used products, as well as resale of used products and selling of new items and so forth.

An award point viewing method in the context of a product distribution system in accordance with the present invention has a step wherein an award point view request is received by way of a communications network from a terminal used by a customer; a step wherein a management system which manages the award points of the customer is consulted to determine the value of the award points of the customer; and a step wherein the value of the award points of the customer determined as a result of consultation with the management system are displayed at the terminal used by the customer by way of the communications network in response to the award point view request which was received.

As a result of this award point viewing method, by issuing an award point view request to a product distribution system by way of a communications network from the customer's own computer terminal, the customer can cause information regarding his award points to be sent from the product distribution system by way of the communications network and to be displayed at his own terminal.

An award point updating method in the context of a product distribution system in accordance with the present invention has a step wherein a transaction order request is received by way of a communications network from a terminal used by a customer; and a step wherein a management system which manages award points of the customer causes the value of the award points to be updated based on the value or corresponding to the content of the received transaction order in response to the transaction order request which was received.

As a result of this award point updating method, upon placement of an order for a transaction by a customer from the customer's own computer terminal to a product distribution system by way of a communications network, the product distribution system automatically updates that customer's award points in correspondence to the contents of that transaction (e.g., addition of award points as a result of purchase of product, subtraction of points as a result of use of award points during purchase of product, etc.).

In a product distribution system in which information processing is performed for resale of a used item in accordance with a first aspect of the present invention, owned item information in which there is recorded information regarding an item owned by a customer is retained; a most-recent resale price is determined, either at regular intervals or on demand, for the item owned by the customer and recorded in that owned item information; and a computer of the customer is notified, by way of a communications network, of that most-recent resale price for the item owned by the customer.

Here, information on a number of one or more used items owned by a customer is previously registered with and retained by the present system. Respective the customer can learn the most-recent resale price for the item owned by him and registered with the present system by receiving same at his own computer from the present system and causing same to appear on their computer displays or the like. As a result, a customer can conveniently learn the current resale price for a used item belonging to the customer without having to go to the trouble of going to or telephoning a used goods shop.

In a preferred embodiment, the present system performs information processing for sale of a used item, and when a customer purchases a product using the present system, information concerning the product so purchased is automatically registered by addition to owned item information as new owned item information for that customer. As a result, the customer is spared the inconvenience of having to himself register the owned item information with the present system.

In a preferred embodiment, the present system can furthermore provide a desired resale price input form for input of a desired resale price by the customer for the item owed by the customer to the computer the customer by way of a communications network. Furthermore, the present system can retain desired resale price information in which there is recorded desired resale price input on that desired resale price input form by the customer. Furthermore, the present system can compare desired resale price for the item of the customer recorded in that desired resale price information with a most-recent resale price for the item of the customer as determined by the present system, and can send a prescribed message related to resale of the item of the customer to the computer of the customer by way of a communications network in correspondence to the results of that comparison. For example, in the event of a match between a desired resale price and a resale price as determined by the present system, e-mail or like notification to the effect that the owned item may be resold at the desired resale price can be sent to the customer. As a result, the customer can sell an item which he owns in a timely fashion before the value thereof would fall below his expectation.

In a product distribution system in which information processing is performed for resale of a used item in accordance with a second aspect of the present invention, owned item information in which there is recorded information regarding an item owned by a customer can be retained, and moreover, a self-assessment form for input by the customer of the condition of the item owned by the customer recorded in that owned item information can be provided to a computer of the customer by way of a communications network. Furthermore, the present system can retain self-assessment information including the condition of the items owned by the customer input by the customer on that self-assessment form; can determine a most-recent resale price, either at regular intervals or on demand, for the item owned by the customer based on that self-assessment information; and moreover, can notify the computer of the customer, by way of a communications network, of the most-recent resale price so determined.

In accordance with the present system, when the customer previously register with the present system a number of used item which he own, he can receive at his own computers from the present system a self-assessment form for assessing the values of the used item which he own, he can cause that form to be displayed by his computer, and he can input information regarding the condition of the item on that self-assessment form. The inputted information is retained by the present system and used for calculation, either at regular intervals or on demand, of most-recent resale price for the item owned by him that are sent to the computer of the customer. As a result a customer can, whenever he wants, easily learn of an accurate and up-to-date resale price for an item which he owns.

In a product distribution system in which information processing is performed for sale of a product and for resale of a used item in accordance with a third aspect of the present invention, owned item information in which there is recorded information regarding an item owned by a customer is retained, and a most-recent resale price for the item owned by the customer is determined, either at regular intervals or on demand, for item owned by the customer and recorded in that owned item information. Furthermore, the present system can send a product catalog page displaying information regarding a product desired by the customer to a computer of the customer by way of a communications network, at which time price difference can be calculated by subtracting the most-recent resale price for the item owned by the customer from a selling price for the product desired by the customer; and moreover, the selling price for the desired product, the most-recent resale price for owned item, and the aforementioned price difference between the two, can be displayed on that product catalog page.

With the present system, when a customer looks at such a catalog page for a product which he is interested in purchasing, the customer can learn not only the selling price for that product, but together therewith can also learn the resale price for something of his own which has previously been registered with the present system as well as the difference in price after subtraction of the resale price of the item he owns from the selling price of the product. A customer can therefore easily learn what the net price would be if he were to trade in an item he owns when buying a desired product.

In a preferred embodiment, the present system furthermore retains award point information in which there is recorded award points acquired by the customer; and when the aforementioned price difference is calculated, not only are the most-recent resale price of the item owned by the customer subtracted from the selling price of the product desired by the customer, but discount corresponding to award points of the customer recorded in the aforementioned award point information are also subtracted therefrom. A customer can therefore easily learn what the net price would be if he were to use award points he has accumulated and trade in an item he owns when buying a desired product.

In a product distribution system in which information processing is performed for sale of a product in accordance with a fourth aspect of the present invention, inventory information in which there are recorded the type and sale term of a product in inventory is retained, and moreover, a reservation form for input of a type of product desired by and purchase term desired by a customer can be provided to a computer of the customer by way of a communications network, and reservation information in which there are recorded type and purchase term of a product desired by the customer and input on that reservation form by the customer is retained. Furthermore, the present system compares type and purchase term of the product desired by the customer and recorded in that reservation information with type and sale term of product in inventory and recorded in the aforementioned inventory information, and sends a message for negotiation with respective customers regarding type or purchase term of products desired by the customer to the computer of the customer by way of the communications network when a match cannot be obtained as a result of that comparison.

With the present system, because the customer can negotiate with the present system by way of his own computer regarding type or purchase terms (e.g., price, condition, etc.) when a product desired for purchase is not (or sale at desired purchase terms, the customer can easily find and buy an item in inventory that is close to that which was desired.

In a product distribution system in which information processing is performed for resale of a used item in accordance with a fifth aspect of the present invention, owned item information in which there is recorded information regarding items owned by customers is retained, and moreover, an item is targeted for a resale campaign and a customer owning an item of the same type as an item targeted for a resale campaign is selected from among the customers based on the aforementioned owned item information. Furthermore, the customer so selected is given notice in the form of a message advising them with respect to resale of the owned item of the same type as an item targeted for a resale campaign.

With the present system, when a customer has previously registered used items which he owns with the present system and one of those used items is later selected by the present system as an object of a resale campaign, then because the customer receives notification to that effect from the present system, he is able to sell such an item which he owns in a timely fashion while the value thereof is still sufficiently appreciated.

In a preferred embodiment, the present system furthermore retains reservation information in which there are recorded types of used items for which purchase is desired by the customer, and moreover, the aforementioned item is targeted for a resale campaign based on type of used items recorded in this reservation information. As a result, type of used items for which demand is currently high or for which it is expected that demand will be high in the future can be determined based on reservation information and these can be made objects of resale campaigns. For this reason, a customer who owns such an item targeted for a resale campaign can easily sell an item which he owns at advantageous terms during a period when demand therefor is high.

The systems of the present invention mentioned hereinabove can typically be implemented using a computer, and a computer program for such purpose may be loaded or installed on such computer by way of any of a variety of media including disk-type storage, semiconductor memory, or the like.

### BRIEF DESCRIPTION OF DRAWINGS

These and other features, aspects, and advantages of the present invention will become better understood with reference to the following description, appended claims, and accompanying drawings where:

FIG. 1 is a block diagram showing the overall constitution of a product distribution system 1 associated with an embodiment of the present invention;

FIG. 2 is a drawing showing an example of a home page at a dedicated website for a MySofmap member, the member's points being displayed thereon;

FIG. 3 is a flowchart showing the flow of processing occurring for registration of customer information when a customer registers as a MySofmap member by way of a website;

FIG. 4 is a flowchart showing the flow of processing occurring for registration of customer information when a customer registers as a Sofmap card member by way of a website;

FIG. 5 is a flowchart showing the flow of processing occurring for registration of customer information when a customer registers as a MySofmap member following registration as a Sofmap card member from a store terminal 2;

FIG. 6 is a portion of a flowchart showing the flow of processing occurring from purchase of a product at a store to the providing of a resale price for the product to the member;

FIG. 7 is a portion of a flowchart showing the flow of processing occurring from purchase of a product at a store to the providing of a resale price for the product to the member;

FIG. 8 is a portion of a flowchart showing the flow of processing occurring from purchase of a product at a website to the providing of a resale price for the product to the member;

FIG. 9 is a portion of a flowchart showing the flow of processing occurring from purchase of a product at a website to the providing of a resale price for the product to the member;

FIG. 10 is a portion of a flowchart showing the flow of processing occurring from purchase of a product at a website to the providing of a resale price for the product to the member;

FIG. 11 is a portion of a flowchart showing the flow of processing occurring from purchase of a product at a website to the providing of a resale price for the product to the member;

FIG. 12 is a portion of a flowchart showing the flow of processing occurring from when a member registers an item he owns with storeless sales system 5 to the providing of a resale price for the owned item to the member;

FIG. 13 is a portion of a flowchart showing the flow of processing occurring from when a member registers an item he owns with storeless sales system 5 to the providing of a resale price for the owned item to the member;

FIG. 14 is a drawing showing an example of a dedicated MySofmap member home page, the total of the resale prices for all items owned by the member being displayed thereon;

FIG. 15 is a flowchart showing the flow of processing occurring in order for storeless sales system 5 to implement the owned item self-assessment capability;

FIG. 16 is a drawing showing an example of a self-assessment form;

FIG. 17 is a flowchart showing the flow of processing occurring in order for storeless sales system 5 to implement the new item purchase price difference display capability;

FIG. 18 is a drawing showing an example of a trade-in price difference display simulation page;

FIG. 19 is a drawing showing an example of a page displaying a reference price with trade-in credit, this being the selling price of a product which a member wishes to purchase less a total trade-in amount and any discount corresponding to points;

FIG. 20 is a flowchart showing the flow of processing occurring in order for storeless sales system 5 to implement the used item searching & reservation capabilities;

FIG. 21 is a drawing showing an example of a reservation manager form;

FIG. 22 is a drawing showing an example of a negotiation page;

FIG. 23 is a flowchart showing the flow of processing occurring in order for storeless sales system 5 to implement the used item demand monitoring resale advice capability;

FIG. 24 is a drawing showing an example of an resale campaign setup form; and

FIG. 25 is a drawing showing an example of an e-mail message automatically sent to members owning an item targeted for a resale campaign and informing them of the campaign.

### DESCRIPTION

The present invention pertains to a capability permitting viewing of award points on a website in the context of a product sale system and to a capability for use and addition of such points. Furthermore, the present invention relates to a product distribution system for carrying out resale and purchase of products using a computer system and a communications network such as the Internet, and in particular pertains to a capability for linking resale and purchase of used products, as well as resale of used products and selling of new items and so forth.

Below, a product distribution system associated with an embodiment of the present invention will be described with reference with to the drawings. Such a product distribution system may handle sale of new products, and resale and purchasing of used products.

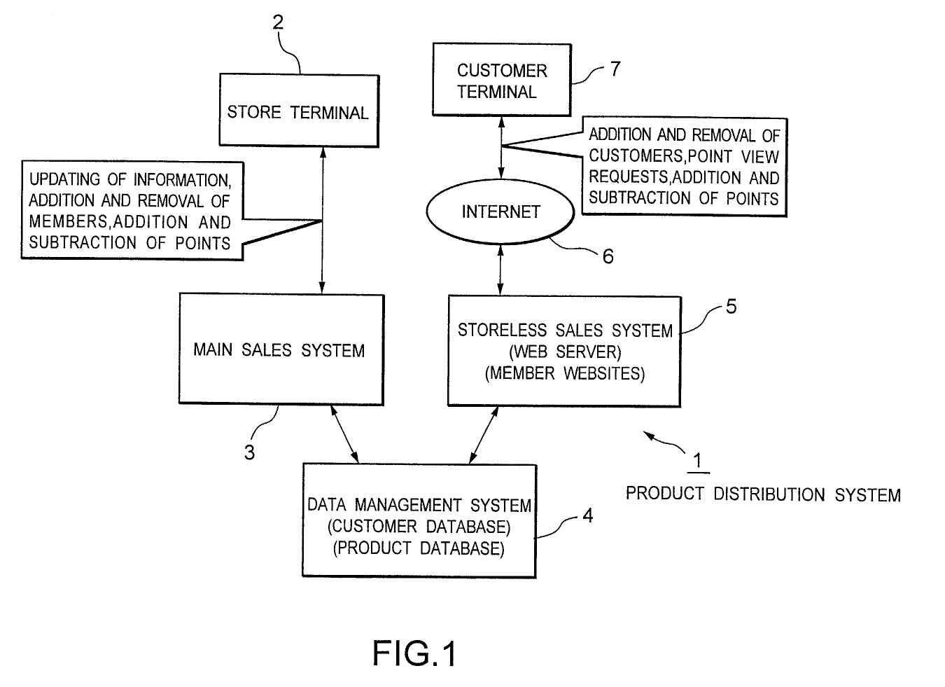

FIG. 1 shows the overall constitution of this product distribution system. Referring to FIG. 1, the overall constitution of this system and an overview of those capabilities among the various capabilities possessed by this system which are particularly related to processing of customer information will first be described.

In this product distribution system 1, respective store terminals 2 (whereas only one such terminal is shown in the drawing, a plurality thereof will in reality ordinarily exist) installed in shop stores are connected so as to permit communication with a main sales system 3. Main sales system 3 primarily handles proccssing of customer information, processing of product sales at stores, and the like in collaboration with store terminals 2. Included among the types of processing of customer information which is carried out here are addition and removal of members participating in award point membership programs, updating of customer information, addition and subtraction of award points, and so forth.

With continued reference to FIG. 1, main sales system 3 is connected so as to permit communication with a data management system 4. Data management system 4 has a customer information database that manages, among other things, members' basic attributes, accumulated award points, information regarding owned used items, assessment information for those used items, desired resale prices for those used items, and carries out management of information related to customers. Data management system 4 furthermore has a product database that manages, among other things, specification information and price information for new products and used products carried by this shop, and carries out management of information related to products. These databases contain a variety of tables and data, and specific examples of such tables and data will be described below as the need to do so arises.

With continued reference to FIG. 1, also connected to data management system 4 so as to permit communication therewith is a storeless sales system 5. Storeless sales system 5 has a World Wide Web server (website) which is connected to the Internet 6, and handles, among other things, processing of customer information and processing of product sales carried out online through a method in which a customer terminal 7 (whereas only one such terminal is shown in the drawing, it goes without saying that a multiplicity thereof will exist in reality) accesses the aforementioned web server by way of the Internet 6. Included among the types of processing of customer information which is carried out here are registration and removal of members participating in award point membership programs, viewing of award points, addition and subtraction of award points, and so forth.

Below, the types of operations carried out during processing of customer information will be described in more specific terms.

Here, we shall assume that the shop is engaged in the sale of new products related to personal computers (hereinafter “PCs”), as well as resale and purchasing of used PC-related products.

A customer (member) participating in an award point membership program (hereinafter called the “AP” card membership program) employing a card issued by this shop possesses an AP card (e.g., a magnetic card on which basic attributes, award points, and the like are recorded) serving as proof that the bearer is a member thereof. When a member presents his AP card at a store during shopping, different numbers of award points which have been established separately for each product are added to the award points recorded on the card as appropriate. The award points obtained by purchase of these products, which will hereinafter be called “rupee points,” can be used as points for obtaining price discounts during subsequent product purchases.

Furthermore, by presenting his AP card when reselling PC-related products which he owns to a PC used goods shop which has a store terminal 2, a member can also receive award points in place of payment for trade-in of those products. The award points obtained in place of payment during trade-in of these products, which will hereinafter be called “pool points,” can be used in place of cash during subsequent product purchases.

The foregoing award point processing at the store is carried out at store terminals 2 and main sales system 3, and rupee points and pool points (hereinafter, the word “points” will be used when referring collectively to both types of award points) of all customers are respectively managed by data management system 4.

With continued reference to FIG. 1, a mechanism by which these award points may be managed is described below.

(1) A customer first carries out an application procedure for membership in the AP card membership program by way of store terminal 2 or by way of the Internet 6 from customer terminal 7, entering his name, date of birth, sex, address, telephone number, and other such basic attributes. The information which has been so entered is registered in the customer database of data management system 4 as customer information for a newly registered AP card member.

(2) A customer who has been newly registered as an AP card member is assigned an AP card member ID which identifies that AP card member, a rupee number which identifies the rupee points belonging to that member, and a pool number which identifies the pool points belonging to that member. Furthermore, the new member receives an AP card on which that AP card member ID is recorded. That AP card member ID, rupee number, and pool number are stored in the customer database with the customer information and management thereof is carried out.

(3) When the member presents his AP card at a store during purchase of a product, service, information, or the like, the number of award points established for the product or the like are added by store terminal 2 to the rupee points already accumulated for the rupee number of that member. Furthermore, if the member indicates that he wishes to use rupee points that he has previously accumulated, the member can purchase the product or the like at a price which is reduced by an amount corresponding to those rupee points, with the rupee points so used being subtracted from the rupee points accumulated for the rupee number of that member.

(4) When the member presents his AP card when he resells a used product to a used goods shop, the number of pool points corresponding to the resale price thereof are added by store terminal 2 to the pool points already accumulated for the pool number of that member. Furthermore, the member can use accumulated pool points in the same manner as cash toward the purchase of products or the like, with the pool points so used being subtracted from the pool points accumulated for the pool number of that member.

(5) Update information for addition and subtraction of rupee points and pool points arising from processing at (3) and (4), above, is sent from store terminal 2 to main sales system 3, and is furthermore sent to data management system 4, and data management system 4 modifies the rupee points and pool points of the customer in question in the customer database.

An AP card member may also view rupee points and pool points accumulated on his card by accessing the web server of storeless sales system 5 from his own customer terminal 7 by way of the Internet 6. With continued reference to FIG. 1, a mechanism by which this may occur is described below.

(1) Before making use of this web service, the AP card member accesses the web server of storeless sales system 5 from customer terminal 7 and registers himself as a member of a web service membership program (hereinafter called the “WS” membership program). In registering, the customer enters his AP card number from customer terminal 7, upon which storeless sales system 5 consults the contents of data registered in the customer database, following which a WS member ID is assigned to the AP card member confirmed as being the person in question, the rupee number and pool number of the AP card are linked to this WS member ID, and the registration in the customer database of data management system 4 is updated to reflect that it is for a “AP card member to which a WS member ID has been linked.”

(2) As a result of the foregoing registration update, the web server of storeless sales system 5 assigns a dedicated website to the customer who became a WS member.

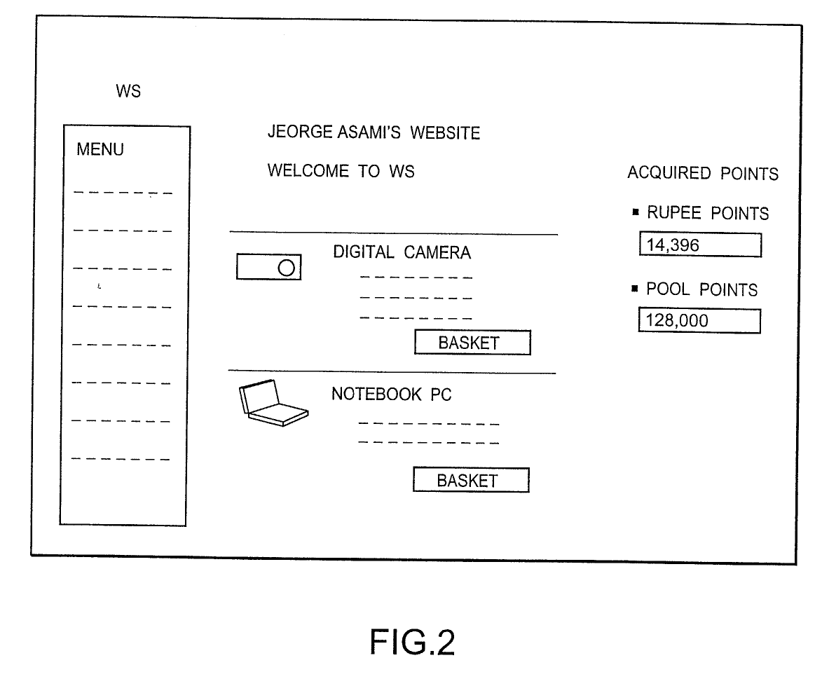

(3) The WS member accesses the web server of storeless sales system 5 from customer terminal 7, and upon entering his WS member ID and password for logging on the web server of storeless sales system 5, the WS member can access the dedicated website for that member. FIG. 2 shows an example of the home page at the dedicated website for WS member “Jeorge Asami.” Based on the WS member ID input at this time, the web server of storeless sales system 5 consults the customer database of data management system 4 and causes the rupee points and pool points respectively accumulated for the rupee number and pool number of that member to be displayed on the dedicated home page for that member as shown by way of example within the encircled region in FIG. 2.

Furthermore, addition and use of points in the same manner as with store transactions is also possible over the Internet 6. With reference again to FIG. 1, a mechanism by which this may occur is described below.

(1) A customer first carries out an application procedure for membership in the AP card program at a store or by way of the Internet 6, entering his name, date of birth, sex, address, telephone number, and other such basic attributes. The information which has been so entered is registered in the customer database of data management system 4 as customer information for an AP card member.

(2) A customer who has been newly registered as a member is assigned an AP card member ID which identities that AP card member, a rupee number which identifies the rupee points belonging to that member, and a pool number which identifies the pool points belonging to that member. Furthermore, the new member receives an AP card on which that AP card member ID is recorded. That AP card member ID, rupee number, and pool number are stored in the customer database with the customer information and management thereof is carried out.

(3) When the AP card member wishes to purchase a product, service, information, or the like at an Internet website possessing a storeless sales system 5, he enters his AP card member ID and password, and places his order. At this time, the number of award points established for the product or the like are added to the rupee points already accumulated for the rupee number of the member.

(4) Furthermore, if there are rupee points or pool points which have been accumulated by the AP card linked to that AP card member ID, the member may use those points. At the time the product or the like is purchased, accumulated rupee points and pool points are displayed, in the same manner as described previously, at customer terminal 7 on a form requesting input of payment method. By indicating the number of points he wishes to use on the form, the member can purchase the product or the like at a price which is reduced by an amount corresponding to those points. The points so used will be subtracted from his card.

(5) Update information for addition and subtraction of points arising from processing by way of web page at (3) and (4), above, is sent from customer terminal 7 to storeless sales system 5 by way of the Internet 6, and is furthermore sent to data management system 4, and data management system 4 modifies the information in the customer database.

As is clear from the foregoing, customer information in the customer database, as well as rupee point and pool point information, can be updated by both the store and the web server, and the member can add or use points from either the store or the web server.

Above, product distribution system 1 of the present embodiment has been described in general. Those capabilities among the various capabilities possessed by product distribution system 1 which are particularly related to used product transactions will next be described.

An overview thereof will first be described.

Referring to FIG. 1, this product distribution system 1 automatically displays resale prices of items owned by respective members (goods such as, for example, personal computers or peripheral equipment therefor which are owned by respective members and which are capable of being subjects of used goods resale transactions conducted by this shop) on the dedicated websites of respective WS members provided by the web server of storeless sales system 5. In order to make use of this capability, respective WS members register the model, specifications, and other such attribute information, and also desired resale price, for items which they own (in the event that the used item was purchased at a shop using the present sales system, registration is carried out automatically at the time of purchase). For each respective owned item which has been registered, product distribution system 1 calculates, either at regular intervals or on demand, a most-recent resale price that would apply if this shop were to buy that owned item. Moreover, the moment that the calculated most-recent resale price for an item for which such registration has been completed by the member who owns it reaches or falls below the desired resale price so registered, product distribution system 1 sends an e-mail message to the member informing him that the owned item's resale price reaches or falls below the desired his resale price. It is thus possible for a member to resell an item which he owns before its value as an investment would fall too low (i.e., before the resale price would fall drastically below the desired amount), without having to himself actively confirm the resale price for the item which he owns by telephone or the like.

In addition to the foregoing owned item resale price display capability, this product distribution system 1 moreover possesses the following capabilities: owned item self-assessment capability, new item purchase price difference display capability, used item searching & reservation capabilities, used item demand monitoring resale advice capability.

“Owned item self-assessment capability” refers to a capability whereby a member inputs various parameters applicable to an item which he owns on a resale assessment form provided by a web server, as a result of which a product distribution system 1 automatically calculates and displays an assessment of the resale price for that owned item.

“New item purchase price difference display capability” refers to a capability whereby when a member is considering purchase of a product using a page provided by a web server, a price difference is displayed such that any discount which may be obtained as a result of accumulation of points by that member and any amount corresponding to a resale price of an item owned by that member are subtracted from the selling price of the product under consideration.

“Used item searching & reservation capabilities” refer to capabilities whereby a member who wishes to purchase a used item inputs the product name and desired price at which he wishes to buy the used item on a page provided by a web server, as a result of which he is informed by way of a display whether such a product exists. In addition, these used item searching & reservation capabilities also make it possible for price negotiations between the member and the shop to be carried out.

“Used item demand monitoring resale advice capability” refers to a capability whereby a used item which many persons are interested in purchasing is designated as a product targeted for a resale campaign, and an advertisement soliciting resale of such a used item targeted for a resale campaign is sent to a member who owns such a used item.

Below, the various capabilities mentioned above related to used item transactions and possessed by a product distribution system 1 associated with the present embodiment are described in detail.

Referring again to FIG. 1, before this product distribution system 1 can provide a customer with services making use of the various capabilities mentioned above, customer information for that customer must have been registered with the system. As described above, customer information is registered at the time a customer becomes an AP card member or a WS member. Processing in connection with registration of this customer information is described in more detail below. Customer information may be registered in accordance with any of the three methods listed below.

(1) WS Member Registration Via Website

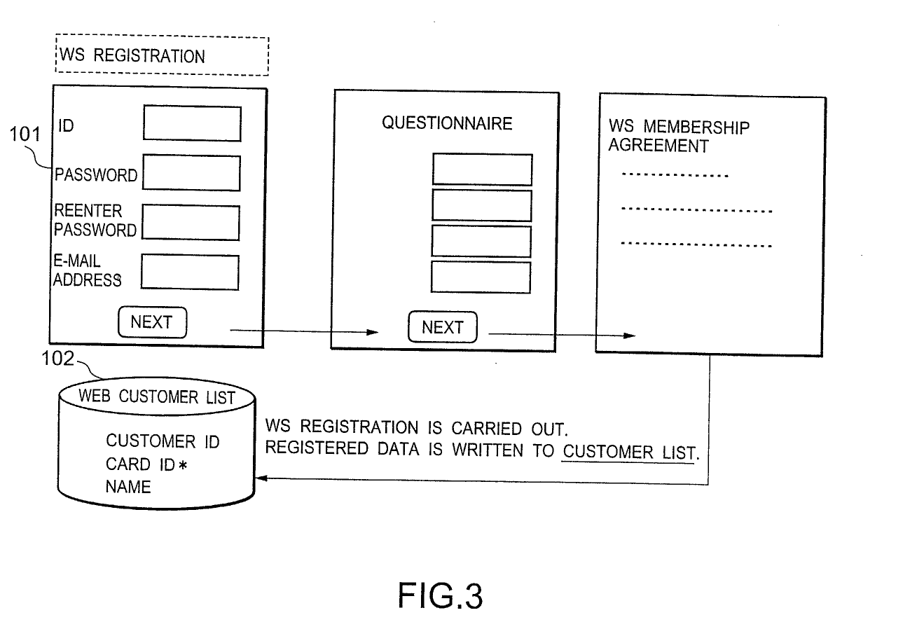

Referring now to FIG. 3, this drawing shows the flow of processing occurring for registration of customer information when a customer registers as a WS member by way of a website provided by a storeless sales system 5.

With continued reference to FIG. 3 and with additional reference to FIG. 1, the flow of such processing will now be described. When customer terminal 7 accesses a prescribed URL belonging to a web server of storeless sales system 5 by way of the Internet, that web server provides that customer terminal 7 with a WS member registration form 101. WS member registration form 101 possesses the following input fields: “ID” (for input of customer ID), “Passwd” (for input of password), “Reenter” (for reinput of password), “Mail address” (for input of e-mail address). Upon entering these items and clicking the “NEXT” button at the bottom of the form, the web server provides customer terminal 7 with a questionnaire form. After the customer enters his responses on the questionnaire form and clicks the “NEXT” button at the bottom of the form, the web server provides customer terminal 7 with a page displaying the terms of a WS membership agreement, and the information entered by the customer at WS member registration form 101 is written to web customer list 102 which is managed by data management system 4. This completes WS member registration.

(2) AP Card Member Registration Via Storeless Sales System 5 Website

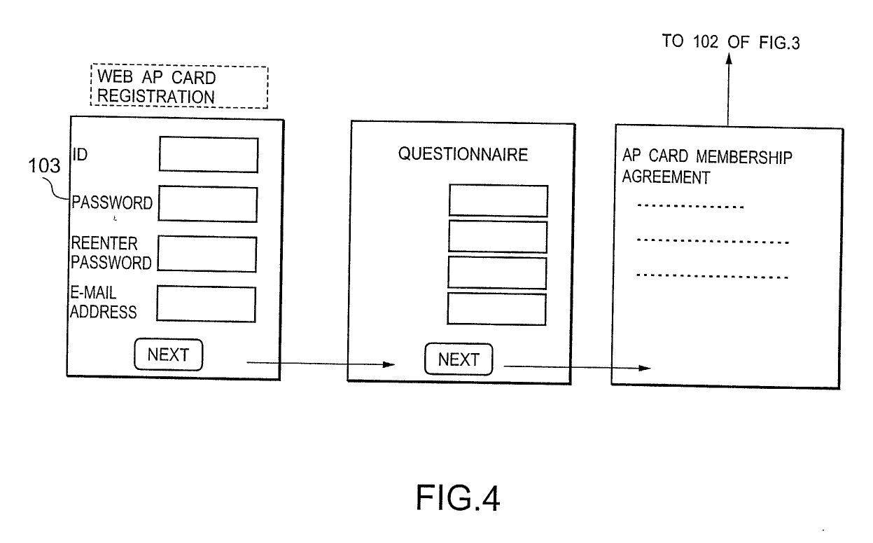

Referring now to FIG. 4, this drawing shows the flow of processing occurring for registration of customer information when a customer registers as an AP card member by way of a website provided by a storeless sales system 5.

With continued reference to FIG. 4 and with additional reference to FIG. 1, the flow of such processing will now be described. When customer terminal 7 accesses a prescribed URL belonging to a web server of storeless sales system 5 by way of the Internet, that web server provides that customer terminal 7 with an AP card member registration form 103. AP card member registration form 103 possesses input fields similar to those of WS member registration form 101; to wit: “ID” (for input of customer ID), “Passwd” (for input of password), “Reenter” (for reinput of password), “Mail address” (for input of e-mail address). Thereafter, the same processing is carried out as was described above for WS member registration via website, with the information entered by the customer at AP card member registration form 103 being written to web customer list 102. After this, a customer information input form, not shown, is sent to customer terminal 7. Upon entering name, address, telephone number, sex, occupation, and other such items at customer terminal 7 and registering the items so entered with the web server, AP card member registration is completed.

(3) WS Member Registration Following AP Card Member Registration at Store

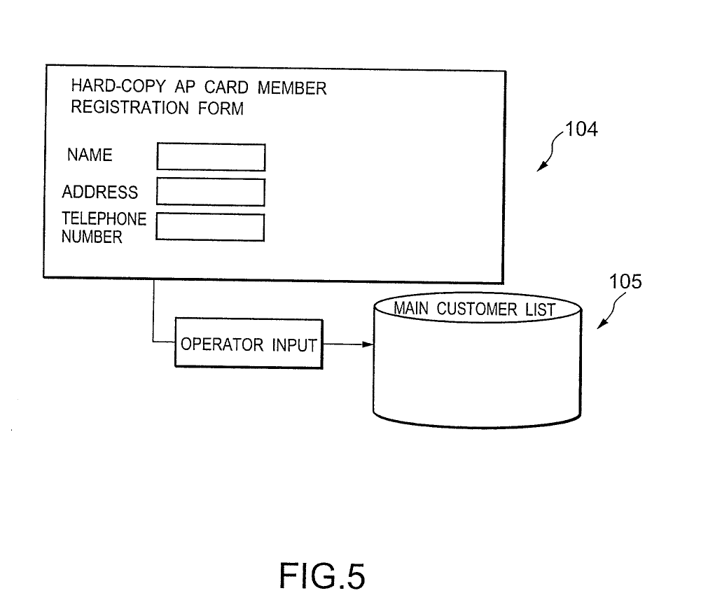

Referring now to FIG. 5, this drawing shows the flow of processing occurring for registration of customer information when a customer registers as a WS member following registration as an AP card member from store terminal 2.

With continued reference to FIG. 5 and with additional reference to FIG. 1, when AP card member registration takes place at a store, a customer enters prescribed items (name, address, telephone number, etc.) on a hard-copy AP card member registration form 104, and the information so entered and the AP card member ID, which is pre-printed on the hard-copy registration form 104, are sent from store terminal 2 by way of an operator through main sales system 3 and are recorded in main customer list 105, which is managed by data management system 4. This completes AP card member registration at a store. Thereafter, WS member registration takes place through the same processing is carried out as was described above with reference to FIG. 3. Moreover, as a result of the WS member registration processing that takes place at this time, an AP card member ID is also written to web customer list 102.

In this way, customer information for display of resale prices of items owned by members is registered. This product distribution system 1 can provide services making use of the aforementioned owned item resale price display capability, owned item self-assessment capability, new item purchase price difference display capability, used item searching & reservation capabilities, used item demand monitoring resale advice capability, and so forth to members for whom customer information has thus been registered. These capabilities are described in more detail below.

The owned item resale price display capability will first be described.

Referring again to FIG. 1, when this product distribution system 1 calculates a resale price for an item owned by a member and the amount so calculated reaches a desired amount specified by the member using the above-described customer information for a member as well as owned item information registered by a method to be described below, product distribution system 1 notifies the member of this fact. Owned item information for a member may be obtained in any of the three situations listed below; but in each such situation, when a product resale price for an owned item is calculated and the amount so calculated reaches an amount specified by the member, the member is notified of this fact.

(i) When Product Purchased at Store (Purchaser Must Be an AP Card Member)

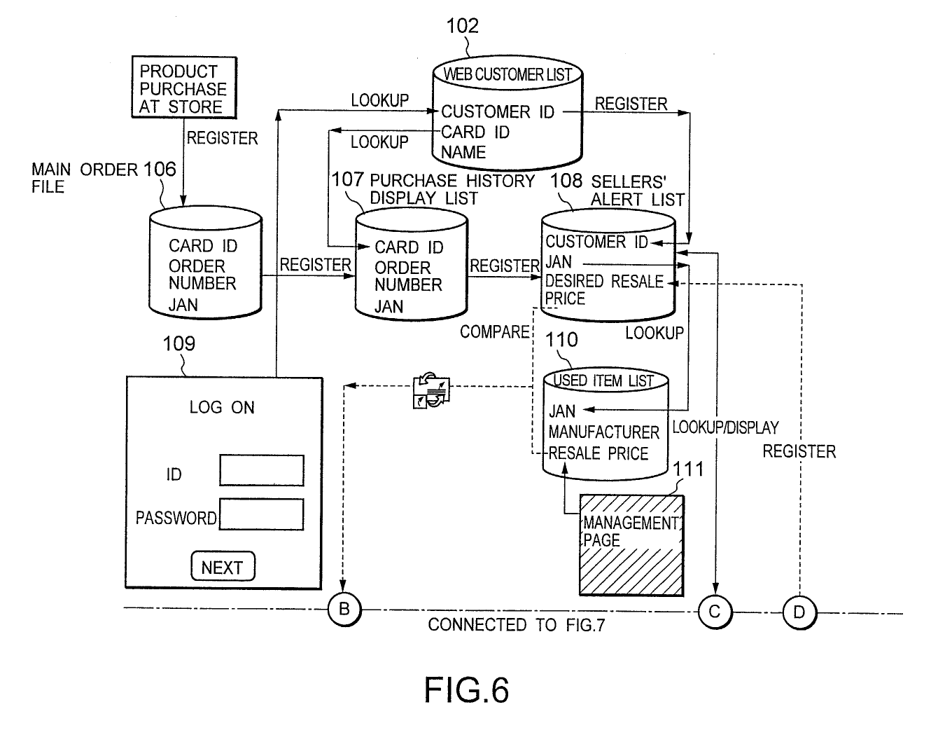

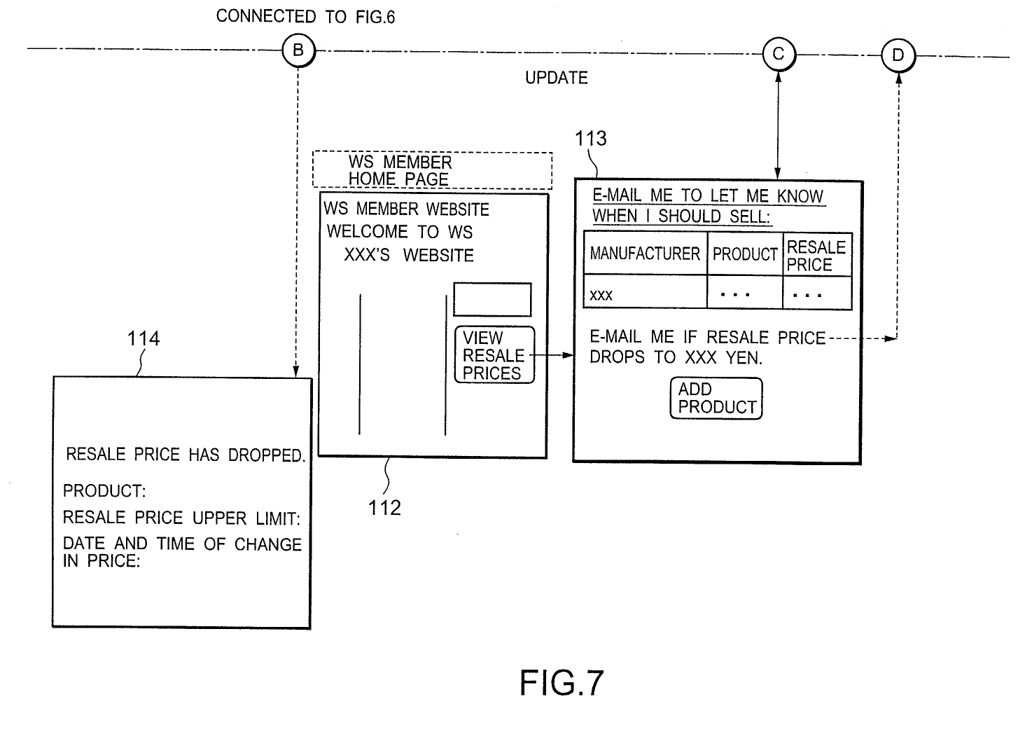

Referring now to FIGS. 6 and 7, these drawings show the flow of processing occurring from purchase of a product (e.g., a PC) at a store to the providing of a resale price for the product to the member. Note that FIGS. 6 and 7 interconnect at points B, C, and D.

With continued reference to FIGS. 6 and 7 and with additional reference to FIG. 1, when a product is purchased at a store, the AP card member ID of the AP card belonging to the member, as well as an order number and product information (information such as product name, product manufacturer, and so forth, which will hereinafter be referred to as “JAN data”), are sent from main sales system 3 and are registered in a main order file 106, which is managed by data management system 4. At this time, of the data registered in main order file 106, the AP card member ID and the JAN data are registered in web purchase history display list 107.

With continued reference to FIGS. 6 and 7, when customer terminal 7 accesses a dedicated WS member home page 112 by way of the Internet, storeless sales system 5 provides that customer terminal 7 with a log-on form 109. When the ID (customer ID) and Passwd (password) have been entered on log-on form 109, the system checks to see whether the customer ID which has been entered is registered in the web customer list 102, and if it is registered therein it provides customer terminal 7 with the dedicated WS member home page 112 (i.e., the computer screen at customer terminal 7 is refreshed and the dedicated WS member home page 112 is displayed). At this time, storeless sales system 5 writes the customer ID contained in web customer list 102, on which it just performed the foregoing check, to a sellers' alert list 108.

When dedicated WS member home page 112 is accessed, storeless sales system 5 searches web customer list 102 for the AP card member ID which corresponds to the customer ID that was entered at the time of log-on. Upon finding it, web purchase history display list 107 is searched for JAN data corresponding to that AP card member ID, and this JAN data is written to sellers' alert list 108.

JAN data (i.e., product name, product manufacturer, etc.) for various used products which are handled by the shop have previously been registered, by way of an operator, in a used item list 110 that is managed by data management system 4. Also registered therein are the current most-recent resale prices for various used products, which have been calculated based on JAN data. Most-recent resale prices are calculated either at regular intervals or on demand, and are written by way of a management page 111 to used item list 110, which is managed by data management system 4. That is, used item list 110 is updated, either at regular intervals or on demand, by way of management page 111.

Provided at dedicated WS member home page 112 is a “VIEW RESALE PRICES” display button. When this button is clicked, storeless sales system 5 accesses sellers' alert list 108, searches for the JAN data corresponding to the customer ID used at the time of log-on, and uses that JAN data to access used item list 110. In addition, storeless sales system 5 acquires resale price information for used products corresponding to that JAN data from used item list 110, and provides customer terminal 7 with a resale price view page 113 displaying information including product names, product manufacturers, and current most-recent resale prices for those used products (i.e., the computer screen at customer terminal 7 is refreshed and the resale price view page 113 is displayed).

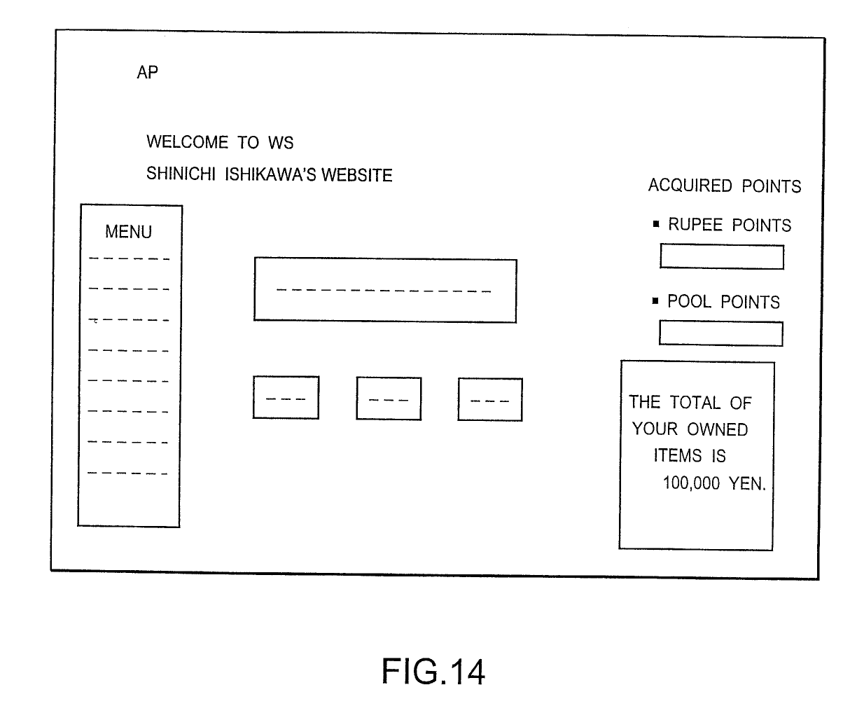

Resale price view page 113 displays, in list form, the relationship between items owned by a member (used items) and the current resale prices thereof. Furthermore, resale prices desired by the customer for those owned items can be entered from resale price view page 113. Desired resale prices so entered arc registered in sellers' alert list 108. This desired resale price information will be displayed on resale price view page 113 the next time that this page 113 is accessed. Furthermore, referring briefly to FIG. 14, the next time that the member accesses his dedicated WS member home page, the total of the resale prices for all items owned by the member will be displayed on that home page, as shown by way of example in the drawing (at the lower right of the page in the example shown at FIG. 14).

Returning to FIGS. 6 and 7, when the aforementioned used item list 110 is updated, storeless sales system 5 compares the resale prices desired by members and registered in sellers' alert list 108 with updated resale prices for the various used items. At this time, if a most-recent updated resale price reaches (or falls below) a resale price desired by some member, the member is notified by sending him, via e-mail, a resale price notification message 114 indicating same.

Briefly describing the foregoing sequence of events from the standpoint of the member, a member accesses dedicated WS member home page 112, and can learn a current resale price or input a desired resale price by jumping to resale price view page 113; and when a resale price reaches (or falls below) a desired resale price, the member receives notification of that fact. As a result, a member can conveniently know a current resale price. Furthermore, resale price view page 113 displays the items owned by a member (used items) and the current resale prices thereof in list form, so it is convenient for a member to learn resale prices even when the number of used products that he possesses is large.

(ii) When Product Purchased at Website (Purchaser Must Be an AP Card Member or WS Member)

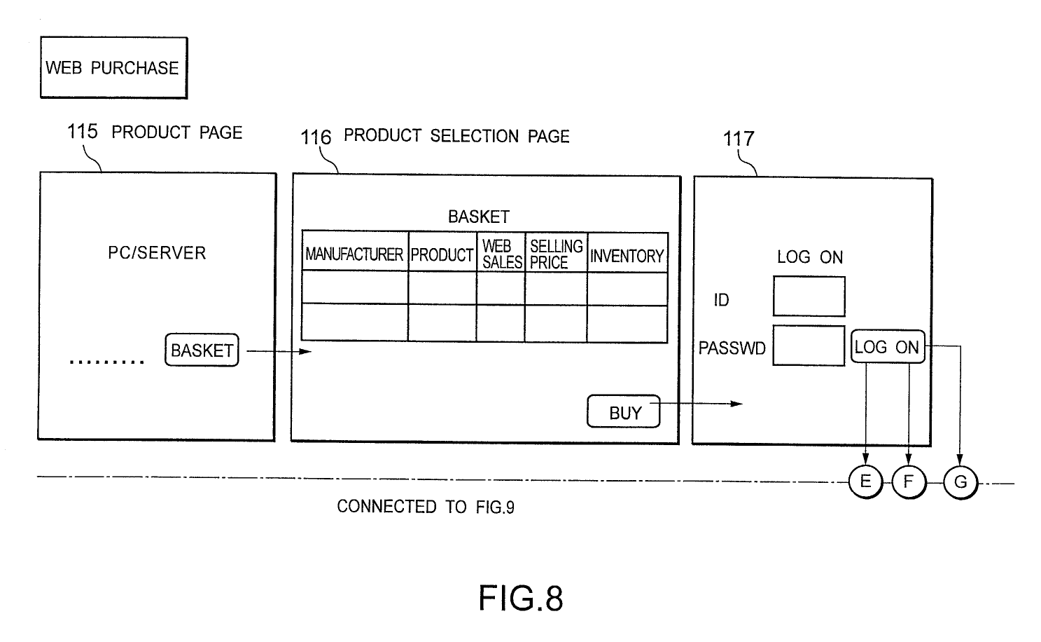

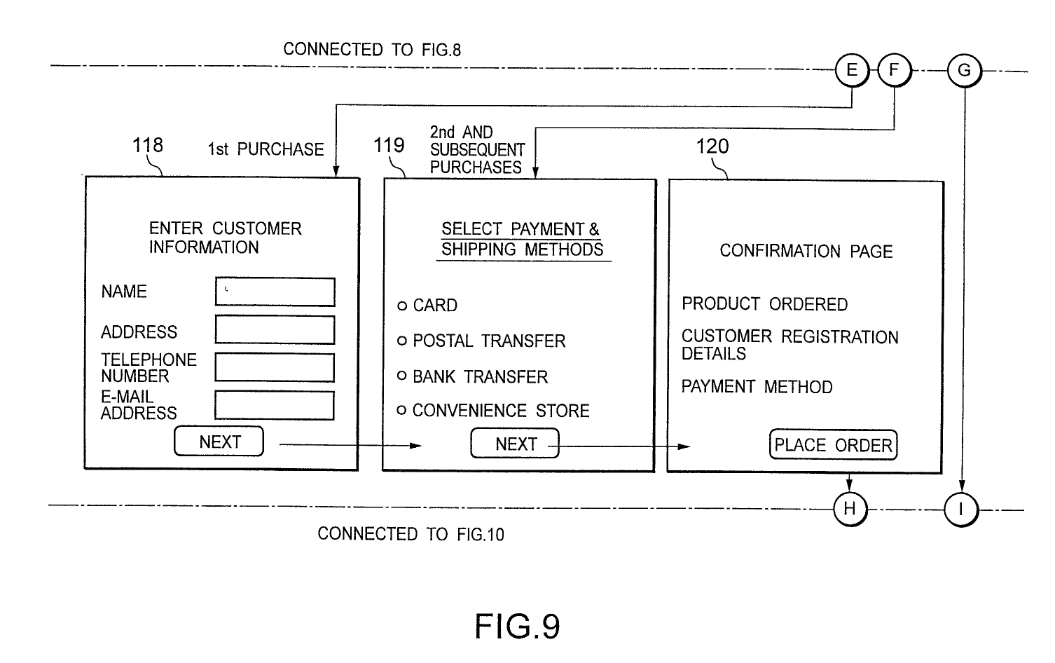

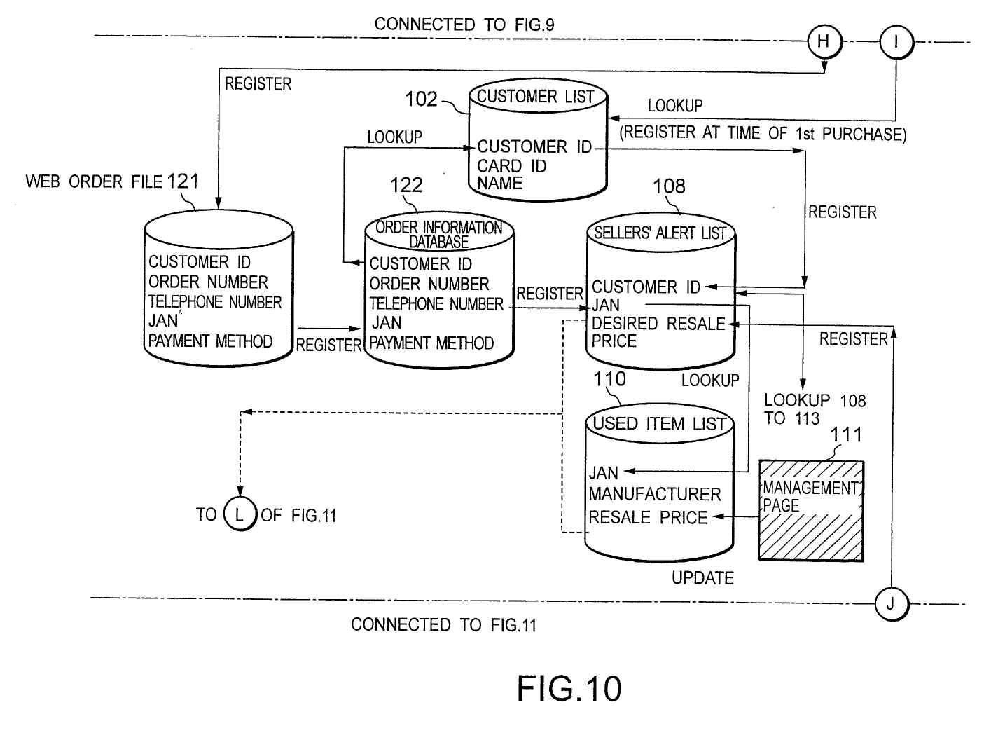

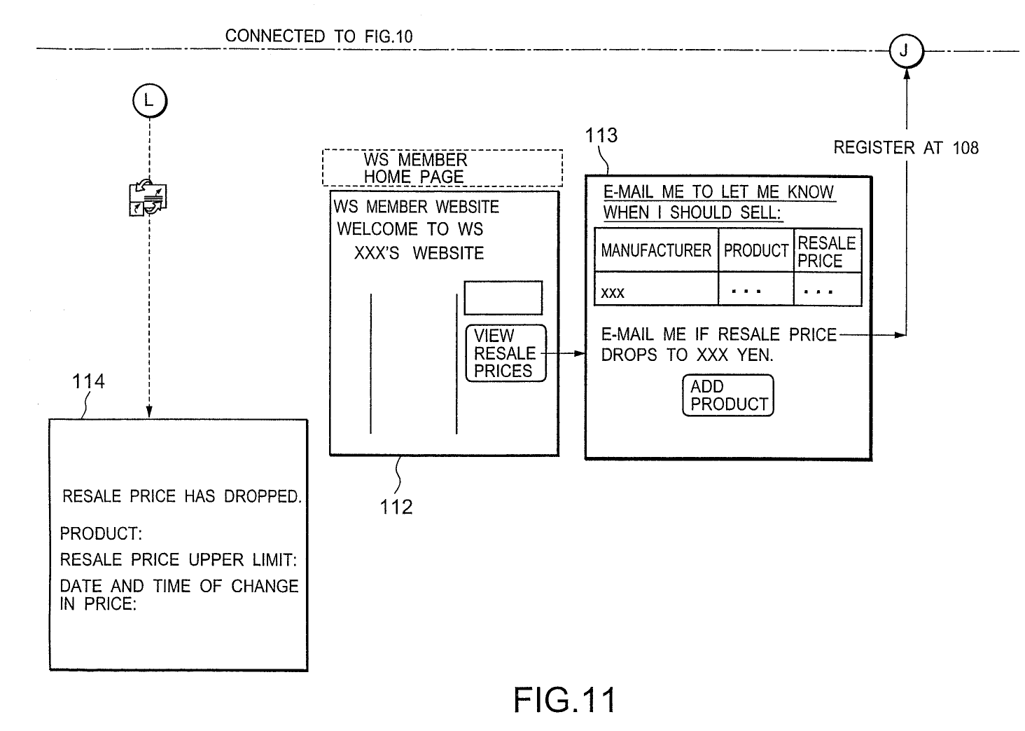

Referring now to FIGS. 8 through 11, these drawings show the flow of processing occurring from purchase of a product (e.g., a PC) at a website to the providing of a resale price for the product to the member. Note that FIGS. 8 and 9 interconnect at points E, F, and G; FIGS. 9 and 10 interconnect at points H and I; and FIGS. 10 and 11 interconnect at points J and L. Furthermore, note that at FIGS. 8 through 11, structural elements similar to elements described with reference to FIGS. 6 and 7 have been given the same reference numerals as were used in those drawings. For the sake of avoiding repetitive description, description of identical elements has been omitted or simplified, and the same is true of the drawings to be described below as well.

With continued reference to FIGS. 8 through 11 and with additional reference to FIG. 1, when a prescribed URL belonging to storeless sales system 5 is accessed, a product page 115 is displayed at customer terminal 7; and upon performing a prescribed operation at that product page 115, a product selection page 116 for selection of a product to be purchased is displayed. Upon performing a prescribed operation at that page 116, a log-on form 117 is displayed. The member logs on by entering his ID (customer ID) and Passwd (password) on that page 117.

With continued reference to FIGS. 8 through 11, when the member logs on, storeless sales system 5 refers to web customer list 102; and if the customer ID which was entered is not registered therein, storeless sales system 5 registers that customer ID in web customer list 102 and provides customer terminal 7 with a customer information input form 118. If the customer ID entered above is already registered in web customer list 102, storeless sales system 5 provides customer terminal 7 with a payment & shipping method selection form 119.

If log-on is successful, customer information input form 118 for input of name, address, telephone number, e-mail address, and other such customer information is displayed at customer terminal 7 (however, note that this is displayed only at the time of the first purchase; this form 118 is not displayed during the second and subsequent purchases). Upon entering all of those items and performing a prescribed operation at this form 118, the computer screen is refreshed and payment & shipping method selection form 119 is displayed (this form 119 is displayed immediately following completion of the log-on procedure during the second and subsequent purchases). Upon entering payment & shipping methods and performing a prescribed operation at that form 119, the computer screen is again refreshed and a product purchase confirmation page 120 is displayed, at which the customer may indicate that he wishes to place an order for the product.

Upon indication of placement of an order, storeless sales system 5 registers the customer ID, order number, customer telephone number, product information (JAN data), and the payment method chosen by the customer in a web order file 121. Furthermore, storeless sales system 5 registers all of the data contained within web order file 121 in an order information database 122 which is managed by data management system 4.

With continued reference to FIGS. 8 through 11, when customer terminal 7 accesses a dedicated WS member home page 112 by way of the Internet, storeless sales system 5 provides that customer terminal 7 with a log-on form 109 just as was described with reference to FIG. 6. When the ID (customer ID) and Passwd (password) have been entered on that log-on form 109, the system checks to see whether the customer ID which has been entered is registered in the web customer list 102, and if it is registered therein it provides customer terminal 7 with the dedicated WS member home page 112 (i.e., the computer screen at customer terminal 7 is refreshed and the dedicated WS member home page 112 is displayed). At this time, storeless sales system 5 writes the customer ID contained in web customer list 102, on which it just performed the foregoing check, to a sellers' alert list 108.

When dedicated WS member home page 112 is accessed, storeless sales system 5 searches order information database 122 for JAN data corresponding to the customer ID that was entered at the time of log-on. Upon finding it, this JAN data is written to sellers' alert list 108.

Processing thereafter is similar to the situation described at (i) When Product Purchased at Store, above. That is, when a “VIEW RESALE PRICES” display button is clicked, a resale price view page 113 displaying, in list form, information including product names, product manufacturers, and current most-recent resale prices for all owned items (used items) for which registration has been completed by that member, including any products just purchased, based on resale price information and JAN data contained in used item list 110 is displayed at customer terminal 7, and the member can enter desired resale prices for respective owned items thereon. When used item list 110 is updated, the updated resale prices are compared with desired resale prices registered in sellers' alert list 108, and if an updated resale price reaches (or falls below) a desired resale price, then the member in question is notified by sending him, via e-mail, a message 114 indicating same. Furthermore, the total of the resale prices for all of a member's registered used items is displayed on the dedicated WS member home page 112 for that member.

(iii) When Member Registers an Item He Owns with Storeless Sales System 5 by Himself (Person Registering Owned Item Must Be an AP Card Member or WS Member)

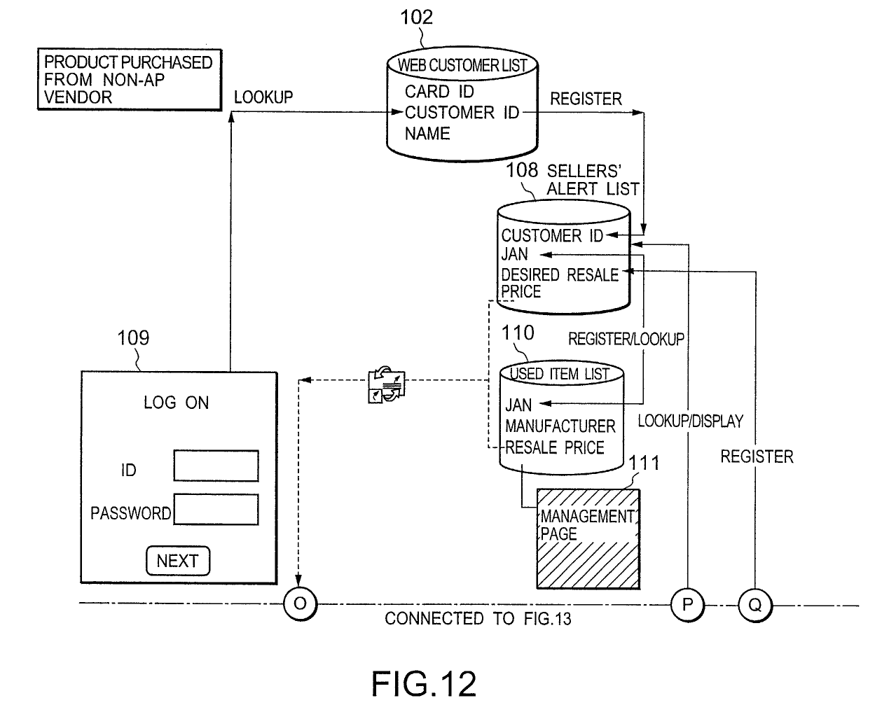

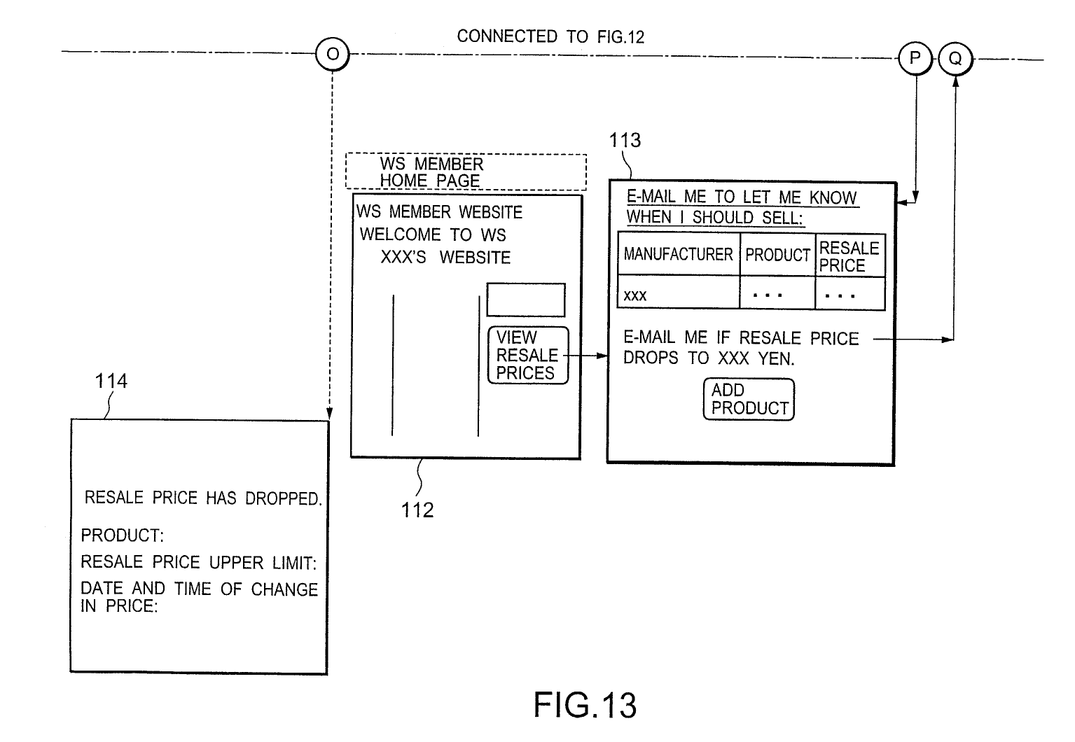

Referring now to FIGS. 12 and 13, these drawings show the flow of processing occurring from when a member registers an item he owns with storeless sales system 5 to the providing of a resale price for the owned item to the member. Note that FIGS. 12 and 13 interconnect at points 0, P, and Q.

With continued reference to FIGS. 12 and 13 and with additional reference to FIG. 1, in registering items he owns with storeless sales system 5, a member accesses dedicated WS member home page 112 by way of log-on form 109, jumps to resale price view page 113 from that page 112, and clicks a product addition button provided at that page 113. Upon so doing, storeless sales system 5 provides a product information input page, not shown. The member enters product manufacturer, model, and other such information for his owned item at that page. The product information so entered (JAN data) is written to sellers' alert list 108.

Processing thereafter is similar to the situation described at (i) When Product Purchased at Store, above. That is, when a “VIEW RESALE PRICES” display button is clicked, a resale price view page 113 displaying, in list form, information including product names, product manufacturers, and current most-recent resale prices for all owned items (used items) for which registration has been completed by that member based on resale price information and JAN data contained in used item list 110 is displayed at customer terminal 7, and the member can enter desired resale prices for respective owned items thereon. When used item list 110 is updated, the updated resale prices are compared with desired resale prices registered in sellers' alert list 108, and if an updated resale price reaches (or falls below) a desired resale price, then the member is notified by sending him, via e-mail, a message 114 indicating same. Furthermore, the total of the resale prices for all of a member's registered used items is displayed on the dedicated WS member home page 112 for that member.

The owned item self-assessment capability possessed by this product distribution system 1 will next be described. As previously mentioned, this capability is such that when a member enters various parameters applicable to an item which he owns on a resale assessment form provided by storeless sales system 5, product distribution system 1 automatically calculates and displays an assessment of the resale price for that owned item.

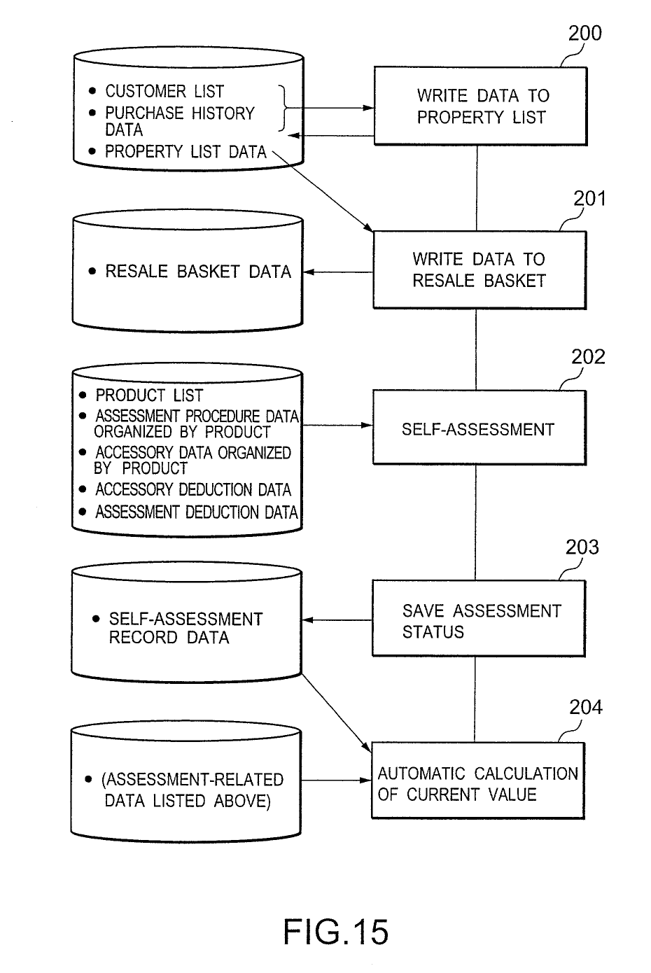

Referring now to FIG. 15, this drawing shows the flow of processing occurring in order for storeless sales system 5 to implement the owned item self-assessment capability.

With continued reference to FIG. 15 and with additional reference to FIG. 1, storeless sales system 5 first, at step 200, writes data for products purchased at this shop in the past by respective members to property lists for respective members based on purchase history data for respective members managed by data management system 4. Furthermore, information for owned items registered by the member himself is likewise written to a property list.

With continued reference to FIG. 15, when a given member thereafter requests that self-assessment be carried out for an owned item following access of his dedicated WS member home page by way of customer terminal 7, storeless sales system 5 proceeds to step 201, displays the property list for that member at customer terminal 7, and solicits selection from the member of which item among the owned items in the property list he wishes to resell. In addition, data for an owned item selected by the member is registered in a resale basket, which is a dedicated receptacle-like resale storage area, and that resale basket is displayed at customer terminal 7.

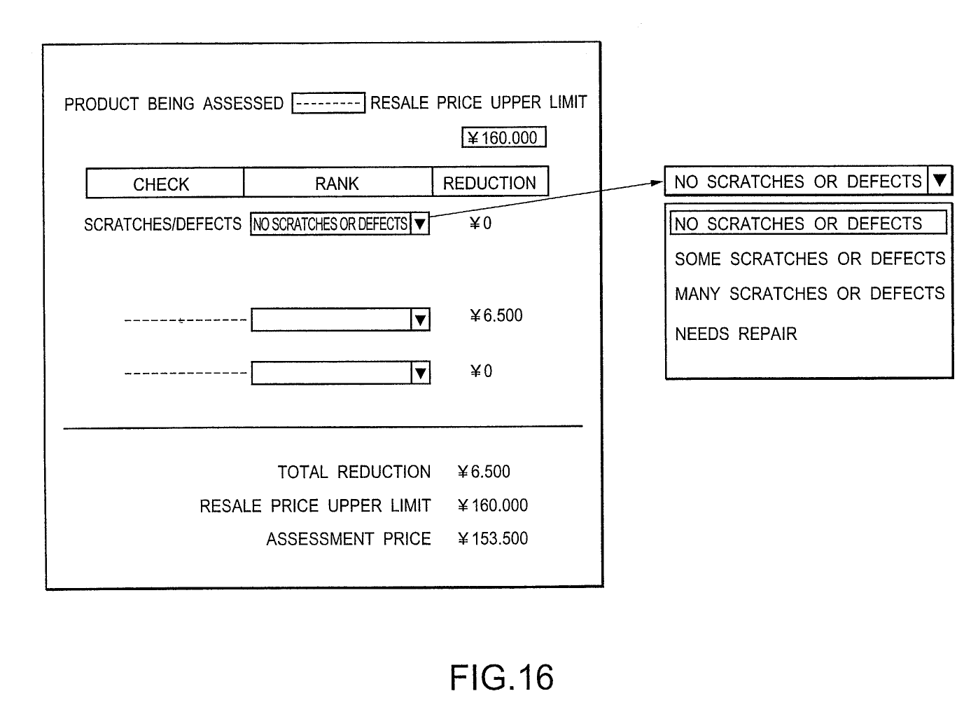

With continued brief reference to FIG. 15, at step 202, after the member has selected a product from that resale basket for which he wishes to resell, storeless sales system 5 next displays at customer terminal 7 an assessment form for detailed assessment of the selected product. Referring now to FIG. 16, the assessment form may be similar to that shown by way of example in FIG. 16. At the assessment form shown in FIG. 16, various assessment parameters and the like are displayed based on the product list, assessment procedure data organized by product, accessory data organized by product, and so forth, which are managed by data management system 4, such parameters including product name and resale price upper limit, as well as condition of any accessories, operational problems, scratches or defects, and the like for the product being assessed. Using this assessment form, the member enters applicable data for respective assessment parameters for the product being assessed. For many assessment parameters, the member can enter data by simply selecting the applicable item from a pulldown menu, as shown in FIG. 16 by way of example to the upper right of the assessment form for the parameter “scratches/defects.” Each time the member enters data for an assessment parameter, storeless sales system 5 calculates deductions for each assessment parameter based on the product list, assessment procedure data organized by product, accessory deduction data, assessment deduction data, and so forth, which are managed by data management system 4, and these deductions are displayed on the assessment form as shown in FIG. 16. In addition, if the member clicks a “SHOW RESULTS OF CALCULATION” button on the assessment form, storeless sales system 5 will determine the total of deductions for all assessment parameters entered, will calculate an assessed value by subtracting the total of those deductions from the resale price upper limit, and will display the results of that calculation on the assessment form as shown in FIG. 16.

Returning now to FIG. 15, self-assessment for one product is thus completed. Upon completion of self-assessment for one product, storeless sales system 5, at step 203, stores the data entered for the respective assessment parameters (assessment information) for that product being assessed, which was entered on the assessment form, in the customer database of data management system 4 as self-assessment record data for that member. The foregoing detailed self-assessment can be carried out separately for all products in the resale basket.

Thereafter, when the member accesses his dedicated WS member home page or another such page displaying resale price, storeless sales system 5 proceeds to step 204, refers to data including the stored self-assessment record data for that member, as well as the product list, assessment procedure data organized by product, accessory data organized by product, accessory deduction data, assessment deduction data, and so forth which were referred to during self-assessment (hereinafter referred to as “assessment-related data”), calculates most-recent assessed values using most-recent deduction information for items owned by that member for which self-assessment has been completed, and displays those most-recent assessed values as resale prices for those owned items. Moreover, the resale price upper limit is displayed as the resale price for an owned item for which self-assessment has not yet been carried out.

The new item purchase price difference display capability will next be described. As previously mentioned, this capability is such that when a member is considering purchase of a product using a page provided by storeless sales system 5, a price difference is displayed such that any discount which may be obtained as a result of accumulation of points by that member and any amount corresponding to a resale price of an item owned by that member are subtracted from the selling price of the product under consideration.

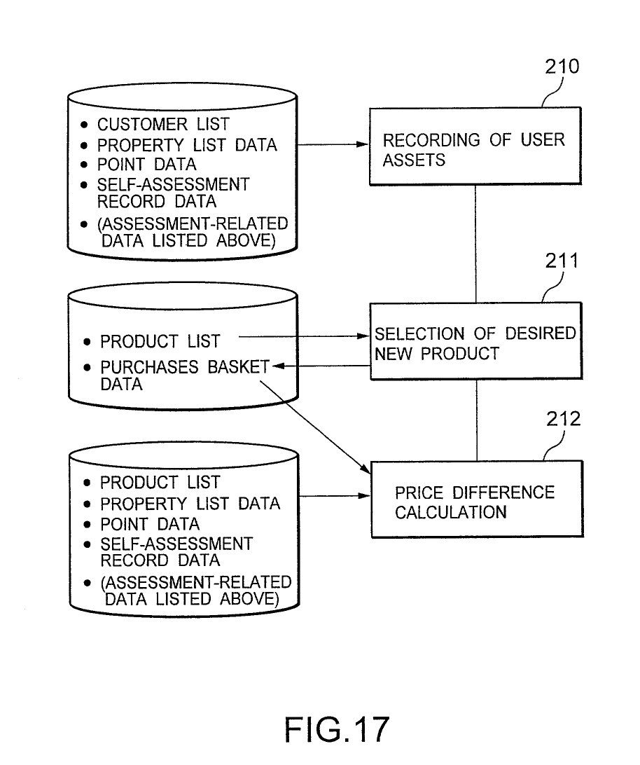

Referring now to FIG. 17, this drawing shows the flow of processing occurring in order for storeless sales system 5 to implement the new item purchase price difference display capability.

With continued reference to FIG. 17 and with additional reference to FIG. 1, when a given member accesses his dedicated WS member home page by way of customer terminal 7, storeless sales system 5, at step 210, first refers to that member's property list data, point data, self-assessment record data, and the aforementioned assessment-related data, as well as customer information for that member within the customer list which is managed by data management system 4, and the like; confirms the rupee points and pool points possessed by that member; and confirms the most-recent accurate resale prices (most-recent assessed values for owned items for which assessment has been completed; most-recent upper-limit resale prices for owned item for which assessment has not been carried out) for respective items owned by that member for which registration has been completed which have been obtained as a result of use of the aforementioned owned item self-assessment capability.

With continued reference to FIG. 17, storeless sales system 5 next, at step 211, searches the product list for data for a product which the member wishes to purchase, places the data for the desired product in a purchases basket, which is a receptacle-like storage area for products to be purchased.

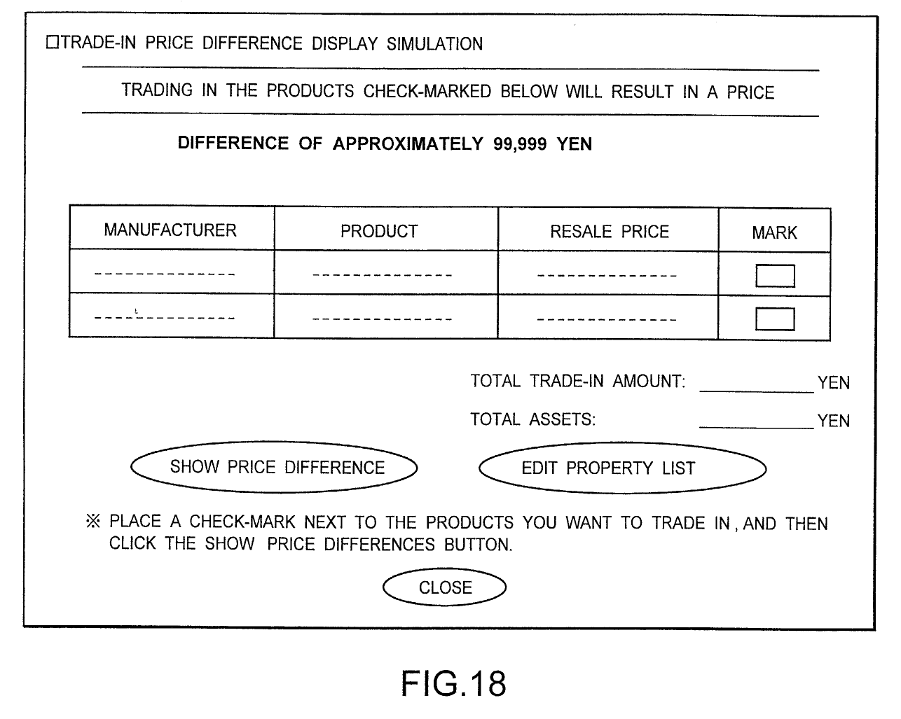

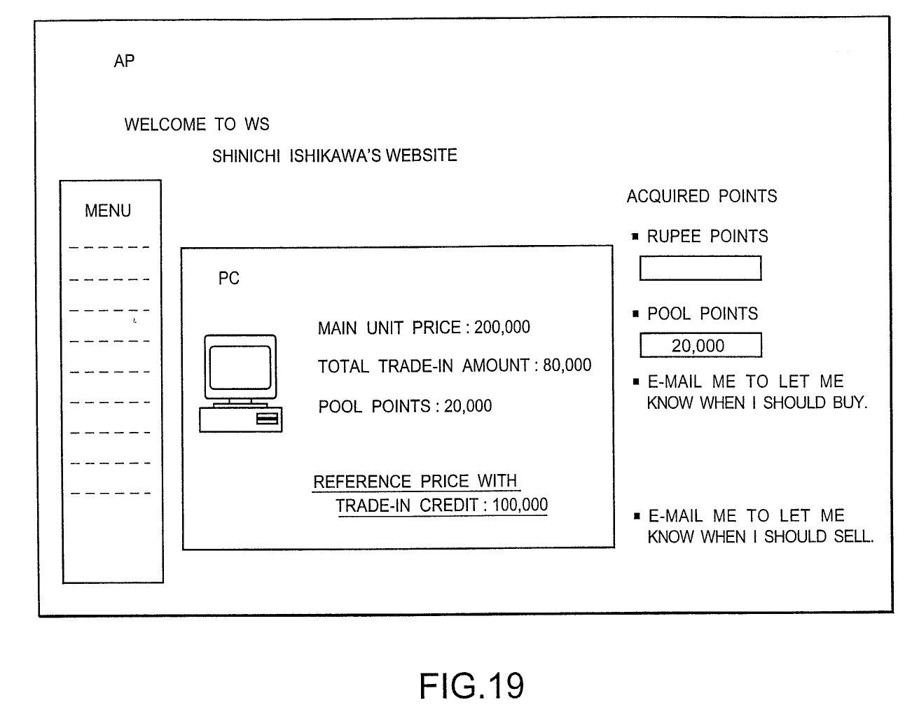

If the member requests a trade-in price difference display simulation, storeless sales system 5 then proceeds to step 212, displays a trade-in price difference display simulation page such as is shown in FIG. 18 at that member's customer terminal 7, and moreover, refers to the product list, the member's property list data, and so forth, and through this price difference display simulation page allows the member to select owned items that he wishes to resell (trade in) from among those items which are owned by the member and for which registration has been completed. After the member has selected the desired owned items, storeless sales system 5 refers to that member's property list data, point data, self-assessment record data, the aforementioned assessment-related data, and the like, acquires most-recent accurate resale prices for the owned items so selected, and moreover, displays manufacturers, product names, and most-recent accurate resale prices for the selected owned items on the price difference display simulation page. In addition, storeless sales system 5 calculates the sum of the resale prices of the owned items so selected (total trade-in amount) and the total of the most-recent resale prices for that member's registered owned items (total assets), and displays this total trade-in amount and this total assets amount on the price difference display simulation page. Thereafter, upon clicking on a “SHOW PRICE DIFFERENCES” button at the price difference display simulation page, storeless sales system 5 subtracts the foregoing total trade-in amount and a discount corresponding to points previously accumulated by that member from the selling prices of the products to be purchased which were placed in the purchases basket at the preceding step 211, sets that price difference as a reference price with trade-in credit, and moreover, after displaying at customer terminal 7 a page such as is shown at FIG. 19 (e.g., a dedicated WS member home page), displays the selling price for the product to be purchased, the total trade-in amount, accumulated points, and the reference price with trade-in credit.

As a result, in purchasing a desired product, the member can easily learn what amount he must pay to be able to make the purchase after trading in items he owns and using points he has accumulated.

Moreover, with the foregoing new item purchase price difference display capability, it is also possible for the member to use not all of the points which he accumulated, but to select a number of points he wishes to use from the points that he has accumulated, and for the reference price with trade-in credit at step 212 to be calculated based on use of only the selected number of points. Furthermore, once this capability has been employed to carryout a price difference display simulation, data resulting from that price difference display simulation may be stored in a database, and a reference price with trade-in credit such as is shown by way of example in FIG. 19 may be automatically calculated and displayed when the member thereafter accesses his dedicated WS member home page and selects a product which he wishes to purchase.

The used item searching & reservation capabilities will next be described. As previously mentioned, these capabilities are such that a member who wishes to purchase a used item inputs the product name and desired price at which he wishes to buy the used item on a page provided by storeless sales system 5, as a result of which he is informed by way of a display whether such a product exists. In addition, these used item searching & reservation capabilities also make it possible for price negotiations between the member and the shop to be carried out.

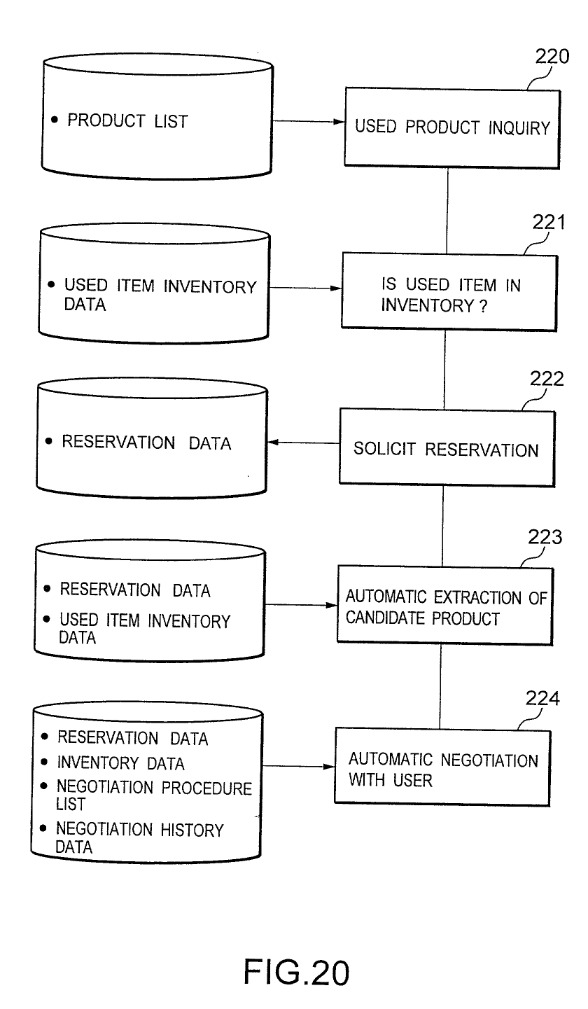

Referring now to FIG. 20, this drawing shows the flow of processing occurring in order for storeless sales system 5 to implement the used item searching & reservation capabilities.

With continued reference to FIG. 20 and with additional reference to FIG. 1, when a given member requests that a search be carried out on the used items for sale that are handled by the shop following access of his dedicated WS member home page by way of customer terminal 7, storeless sales system 5, at step 220, searches the property list for data pertaining to used items for sale that match the desired parameters of that member, and displays the list of retrieved used items at the customer terminal 7 of that member.

With continued reference to FIG. 20, when the member then selects a used item which he wishes to purchase from the list of retrieved used items handled by the shop, storeless sales system 5, at step 221, refers to used item inventory data managed by data management system 4, determines whether or not the used item he wishes to purchase is in inventory, and displays the result of this determination at the customer terminal 7 of that member. If the result is that the used item is in inventory, then the member may at that point initiate the process of purchasing the desired used item.

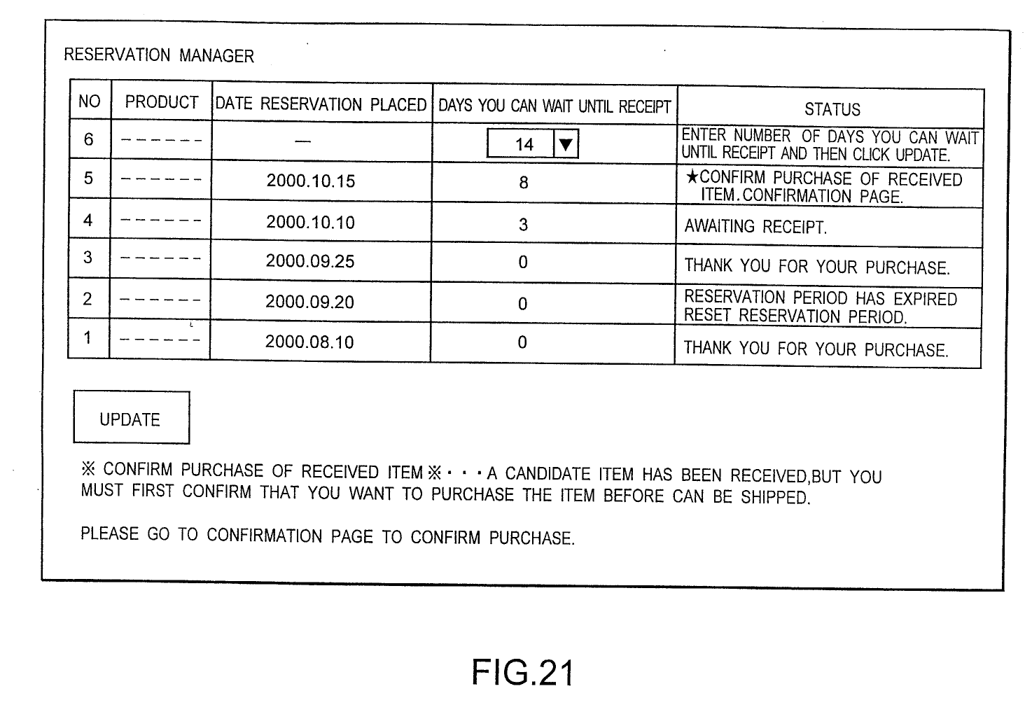

In the case of a used item which is not in inventory, storeless sales system 5 may, at step 222, initiate the process of soliciting a reservation from the member. In such a case, storeless sales system 5 displays a reservation manager form such as is shown by way of example at FIG. 21 at customer terminal 7 of that member, with the product name of the used item which was not inventory being entered on this reservation manager form. The member inputs on this reservation manager form the number of days he can afford to wait until receipt of the used item just entered, and, although not shown in the drawing, the member may also if he likes enter a desired purchase price and condition specification, and the member clicks an “UPDATE” button, upon which storeless sales system 5 regards that the entered used item which the number of days was inputted as an actual reservation item, and registers the product name, number of days until receipt, desired purchase price, condition, and also the receipt status for that used item (initially “awaiting receipt”), and so forth as reservation data for that member in the customer database managed by data management system 4.

Moreover, as shown by way of example at FIG. 21, not only is the newly entered used item displayed on the reservation manager form, but reservation data for previously registered reservation items is also displayed together therewith. The member can view his reservation manager form on demand, and can therefore learn the receipt status of respective reservation items at any time.

Returning to FIG. 20, storeless sales system 5 proceeds to step 223, either at regular intervals or on demand, and compares reservation data for respective members with used item inventory data, searching for used items in inventory that meet the parameters entered as reservation items by respective members, and if a used item meeting such parameters is found in inventory, selects the reservation item corresponding thereto, and moreover, notifies the member via e-mail of receipt of such item.

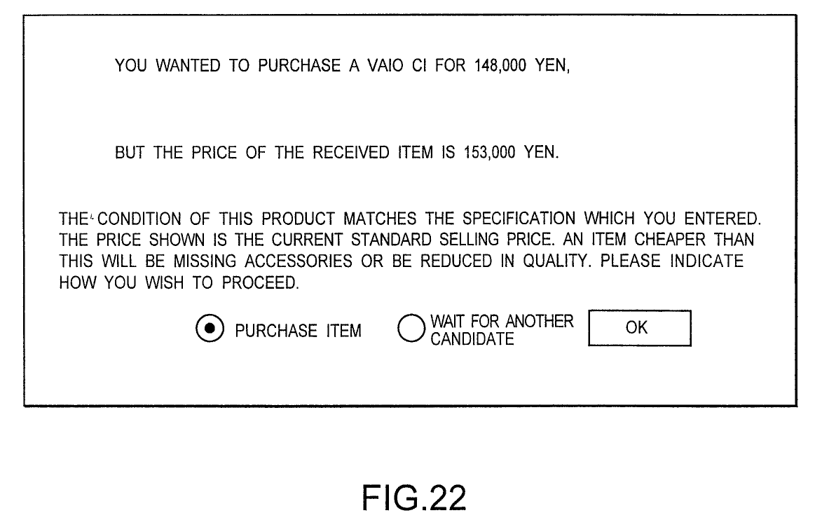

Furthermore, in the event that as a result of the processing at step 223, a used item in inventory is found that is extremely close to, being only slightly different from, reservation data for a given used item of a given member (e.g., product name and condition match, but the selling price is slightly higher than the desired purchase price), storeless sales system 5 proceeds to step 224, and, in accordance with a negotiation procedure list managed by data management system 4, creates a negotiation page (in the present example, a page for negotiating price) such as is shown by way of example in FIG. 22 for the purpose of urging purchase after negotiation with that member with respect to the price, quality, or the like of the slightly different used item in inventory, and displays that negotiation page at the customer terminal 7 of the member (alternatively an e-mail message to the same effect as the negotiation page may be sent to that member).

With continued reference to FIG. 21 and additional brief reference to FIG. 22, if the member selects “PURCHASE ITEM” and clicks the “OK” button from this negotiation page, then, although not shown in the drawing, storeless sales system 5 proceeds to a process for allowing the member to purchase that used item in inventory at the price, condition, and other such parameters indicated by the used item inventory data.

The used item demand monitoring resale advice capability will next be described. This capability is such that a used item which many persons are interested in purchasing is designated as a product targeted for a resale campaign, and an advertisement soliciting resale of such a used item targeted for a resale campaign is sent to a member who owns such a used item.

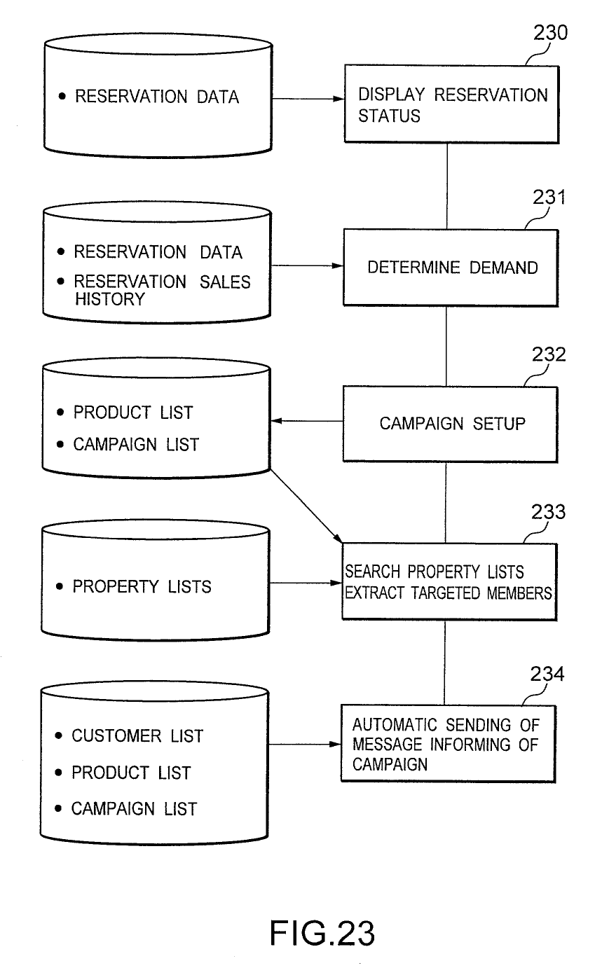

Referring now to FIG. 23, this drawing shows the flow of processing occurring in order for this product distribution system 1 to implement the used item demand monitoring resale advice capability.

With continued reference to FIG. 23 and with additional reference to FIG. 1, when a used item reservation status report request is received from a system terminal device, not shown, store terminal 2, or the like, main sales system 3 or storeless sales system 5 of this product distribution system 1, at step 230, refers to the reservation data registered by means of the foregoing used item searching & reservation capabilities, determines reservation status; i.e., what volume of reservations are being placed for what models of used items at what desired purchase prices, and displays this reservation status report at the system terminal device or the like from which the request therefor was received.

Moreover, if so requested by that system terminal device, main sales system 3 or storeless sales system 5, at step 231, may display that reservation status report in a manner that will indicate trends in time, or based on reservation sales history data, may display trends in time with regard to reservation sales history. As a result, an operator at that system terminal device can easily ascertain what level of demand currently exists for which models of used items and can easily extrapolate future demand therefor, and is thus able to determine which models can be expected to be in increasing demand in the near future.

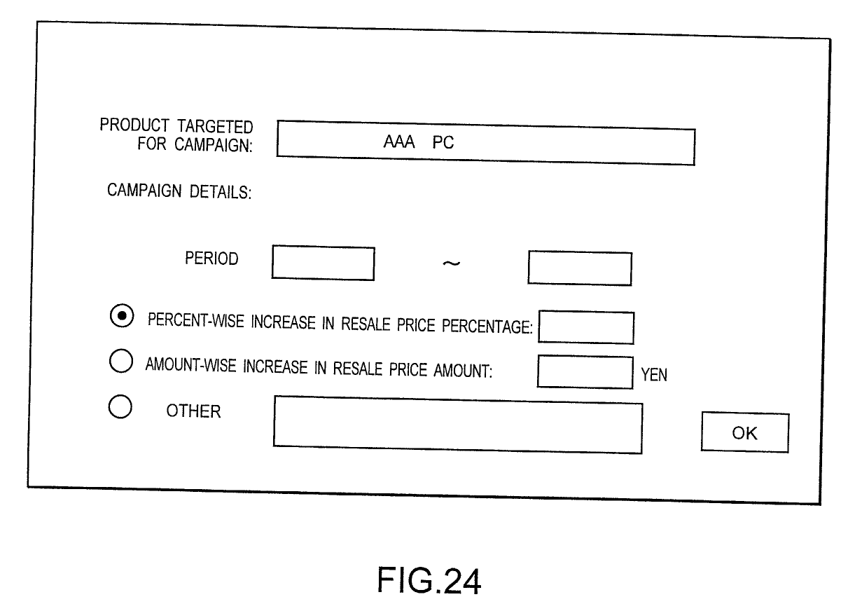

Furthermore, if a resale campaign setup request is received from that system terminal device, main sales system 3 or storeless sales system 5 proceeds to step 232 and displays at that system terminal device a resale campaign setup form such as is shown by way of example at FIG. 24. The operator enters on that resale campaign setup form the details of the resale campaign to be implemented. For example, the operator may enter as an item to be targeted for resale campaign the product name of a used item for which it has been determined that demand is currently high or demand is expected to be high in the near future, may enter campaign start and end dates, and may enter a percent or amount by which the resale price is to be increased or other such favorable resale terms applicable to the item targeted for campaign during the campaign period. When the operator clicks on the “OK” button following entry of campaign details on that resale campaign setup form, main sales system 3 or storeless sales system 5 registers the details of the campaign so entered in a campaign list managed by data management system 4, and moreover, at the field in the product list corresponding to the product which has been targeted for campaign, indicates that the product has been targeted for campaign, writes the resale price which is to be effective during the campaign period, and so forth.

With continued reference to FIG. 23, storeless sales system 5 thereafter proceeds to step 233, refers to the campaign list or product list to determine items targeted for campaign, and moreover, refers to the property lists of members to extract those members who own an item targeted for campaign.

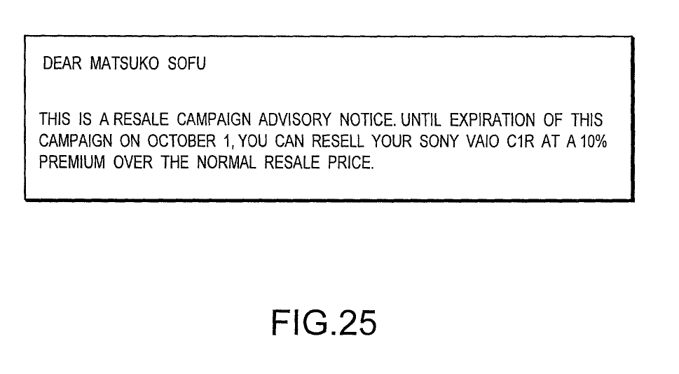

Prior to that start of that resale campaign or at an appropriate time during the campaign period, storeless sales system 5 then proceeds to step 234, refers to the customer list, acquires the names and e-mail addresses of the aforementioned extracted members, and moreover, refers to the campaign list and product list to determine the details of the campaign, including the item targeted for campaign, the campaign period, favorable resale terms applicable during the campaign, and so forth. In addition, this information is used to create an e-mail message, such as is shown by way of example at FIG. 25, informing the respective aforementioned extracted members of the details of the campaign and encouraging them to resell the item targeted for campaign, and this e-mail message is automatically sent to those respective aforementioned extracted members. As a result, members who own items targeted for campaign can easily resell the items which they own at an appropriate time when they can obtain favorable terms, and moreover, a used goods shop can efficiently acquire an inventory of used items for which demand is high.

Whereas a preferred embodiment of the present invention has been described above, these examples have been presented merely for purposes of describing the invention and it not intended that the invention should be limited thereby. Accordingly, the present invention may be carried out in the context of a wide variety of modes and embodiments other than those specifically presented herein without departing from the spirit of the invention.

What is claimed is:

1. An award point viewing method in the context of a product distribution system, said award point viewing method having:
a) a step wherein an award point view request is received by way of a communications network from a terminal used by a customer;
b) a step wherein a management system which manages the award points of the customer is consulted to determine the value of the award points of the customer; and
c) a step wherein the value of the award points of the customer determined as a result of consultation with the management system is displayed at the terminal used by the customer by way of the communications network in response to the award point view request which was received.

2. An award point updating method in the context of a product distribution system, said award point updating method having:
a) a step wherein a transaction order request is received by way of a communications network from a terminal used by a customer; and
b) a step wherein a management system which manages award points of the customer causes the value of the award points to be updated based on the value of award points corresponding to the content of the received transaction order in response to the transaction order request which was received.

3. A method for providing information to a customer in the context of a product distribution system in which information processing is performed for resale of a used item, said method for providing information having:
a) a step wherein owned item information in which there is recorded information regarding an item owned by the customers is retained;
b) a step wherein most-recent a resale price is determined, either at regular intervals or on demand, for the item owned by the customer and recorded in the owned item information; and
c) a step wherein a computer of the customer is notified, by way of a communications network, of the most-recent resale price for the item owned by the customer.

4. A method for providing information according to claim 3 further having a step wherein, when the customer purchases a product, information concerning the product purchased by the customer is added to the owned item information as new owned item information for the customer.

5. A method for providing information according to claim 3 further having:
a) a step wherein a desired resale price input form for input of a desired resale price by the customer for the item owned by the customer is provided to computers of the customer by way of the communications network;
b) a step wherein desired resale price information indicating the desired resale price input by the customer on the desired resale price input form is retained;
c) a step wherein the desired resale price for the item owned by the customer recorded in the desired resale price information is compared with most-recent resale price for the item owned by the customer determined in the most-recent resale price determining step; and
d) a step wherein a prescribed message related to resale of the item owned by the customer is sent the computer of the customer by way of the communications network in correspondence to the results of comparison at the comparing step.

6. A product distribution system in which information processing is performed for resale of a used item, said product distribution system comprising:
a) owned item information retaining means that retains owned item information in which information regarding an item owned by a customer is recorded;
b) resale price determining means that determines a most-recent resale price, either at regular intervals or on demand, for the item owned by the customer and recorded in the owned item information; and
c) notification means that notifies a computer of the customer by way of a communications network of the most-recent resale price for the item owned by the customer.

7. A product distribution system according to claim 6 further comprising automatic registration means that, when the customer purchase a product, adds information concerning the product purchased by the customer to the owned item information as new owned item information for the customer.

8. A product distribution system according to claim 6 further comprising:
a) desired resale price input means that provides, to the computer of the customer by way of a communications network, a desired resale price input form for input of a desired resale price by the customer for an item owned by him;
b) desired resale price retaining means that retains desired resale price information indicating the desired resale price input on the desired resale price input form by the customer;
c) price comparing means that compares the desired resale price for the item of the customer recorded in the desired resale price information with the most-recent resale price for the item of the customer determined by the resale price determining means; and
d) message sending means that sends a prescribed message related to resale of the item of the customer to the computer of the customer by way of the communications network in correspondence to the result of comparison by the price comparing means.

9. A method for providing information to a customer in the context of a product distribution system in which information processing is performed for resale of a used item, said method for providing information having:
a) a step wherein owned item information in which there is recorded information regarding an item owned by a customer is retained;
b) a step wherein a self-assessment form for input by the customer of the condition of the item owned by the customer recorded in the owned item information is provided to a computer of the customer by way of a communications network;
c) a step wherein self-assessment information including the condition of the item owned by the customer input by the customer on the self-assessment form and is retained;
d) a step wherein a most-recent resale price is determined, either at regular intervals or on demand, for item owned by the customer based on the self-assessment information; and
e) a step wherein the computer of the customer is notified of the most-recent resale prices for the item owned by the customer by way of the communications network.

10. A product distribution system in which information processing is performed for resale of a used item, said product distribution system comprising:
a) owned item information retaining means that retains owned item information in which information regarding an item owned by a customer is recorded;
b) self-assessment form providing means that provides a self-assessment form for input by the customer of the condition of the item owned by the customer recorded in the owned item information to a computer of the customer by way of a communications network;
c) self-assessment information retaining means that retains self-assessment information including the condition of the item owned by the customer input by the customer on the self-assessment form;
d) resale price determining means that determines a most-recent resale price, either at regular intervals or on demand, for the item owned by the customer based on the self-assessment information; and
e) notification means that notifies the computer of the customer by way of the communications network of the most-recent resale price for the item owned by the customer.

11. A method for providing information to a customer in the context of a product distribution system in which information processing is performed for sale of a product or for resale of a used item, said method for providing information having:
a) a step wherein owned item information in which there is recorded information regarding an item owned by a customer is retained;
b) a step wherein a most-recent resale price for the item owned by the customer is determined, either at regular intervals or on demand, and recorded in the owned item information;
c) a step wherein a product catalog page displaying information regarding a product desired by the customer is sent to a computers of the customer by way of a communications network;
d) a step wherein a price difference is calculated by subtracting the most-recent resale price for the item owned by the customer from a selling price for the product desired by the customer; and
e) a step wherein the selling price for the product desired by the customer, the most-recent resale price for the item owned by the customer, and the price difference between the two, are displayed on the product catalog page sent to the computer of the customer.

12. A method for providing information according to claim 11 further having a step wherein award point information in which there is recorded a value of award points acquired by the customer is retained; and:
a) at the step in which price difference is calculated, the price difference is determined by subtracting not only the most-recent resale price from the selling price, but also by subtracting therefrom discount corresponding to the value of the award points of the customer recorded in the award point information; and
b) at the step in which display on the product catalog page is carried out, the value of the award points used in determining the price difference are also displayed on the product catalog page.

13. A product distribution system in which information processing is performed for sale of a product or for resale of a used item, said product distribution system comprising:
a) owned item information retaining means that retains owned item information in which information regarding an item owned by a customer is recorded;
b) resale price determining means that determines a most-recent resale price for the item owned by the customer, either at regular intervals or on demand, for the item owned by the customer and recorded in the owned item information;
c) product catalog page providing means that sends a product catalog page displaying information regarding a product desired by the customer to a computer of the customer by way of a communications network;
d) price difference calculating means that calculates a price difference by subtracting the most-recent resale price for the item owned by the customer from a selling price for the product desired by the customer; and
e) price display means that displays the selling price for the product desired by the customer, the most-recent resale price for the item owned by the customer, and the price difference between the two, on the product catalog page sent to the computer of the customer.

14. A product distribution system according to claim 13 further comprising award point information retaining means that retains award point information in which there is recorded a value of the award points acquired by the customer;
a) the price difference calculating means being such that the price difference is determined by subtracting not only the most-recent resale price from the selling price, but also by subtracting therefrom discount corresponding to the value of the award points of the customer recorded in the award point information; and
b) the price display means being such that the value of the award points used in determining the price difference are also displayed on the product catalog page.

15. A method for providing information to a customer in the context of a product distribution system in which information processing is performed for sale of a product, said method for providing information having:
a) a step wherein inventory information in which there are recorded the type and sale term of a product in inventory is retained;
b) a step wherein a reservation form for input of a type of product desired by and purchase terms desired by the customer is provided to a computer of the customer by way of a communications network;
c) a step wherein reservation information in which there are recorded type and purchase term of the product desired by the customer and input on the reservation form by the customer is retained;
d) a step wherein the type and the purchase term of the product desired by the customer and recorded in the reservation information are compared with type and sale term of one or more products in inventory and recorded in the inventory information; and
e) a step wherein a message for negotiation with the customer regarding the type or the purchase term of the product desired by the customer is sent to the computer of the customer by way of the communications network when a match cannot be obtained as a result of comparison at the comparing step.

16. A product distribution system in which information processing is performed for sale of a product, said product distribution system comprising:
a) inventory information retaining means that retains inventory information in which there are recorded type and sale term of one or more product in inventory;
b) reservation form providing means that provides a reservation form for input of a type of a product desired by and purchase term desired by the customer to a computer of the customer by way of a communications network;
c) reservation information retaining means that retains reservation information in which there are recorded the type and the purchase term of the product desired by the customer and input on the reservation form by the customer;
d) comparing means that compares the type and the purchase term of the product desired by the customer and recorded in the reservation information with the type and the sale terms of the one or more products in inventory and recorded in the inventory information; and
e) communication means that sends a message for negotiation with the customer regarding the type or the purchase term of the product desired by the customer to the computer of the customer by way of the communications network when a match cannot be obtained as a result of comparison by the comparing means.

17. A method for providing information to a customer in the context of a product distribution system in which information processing is performed for resale of a used item, said method for providing information having:
a) a step wherein owned item information in which there is recorded information regarding items owned by customers is retained;
b) a step wherein an item is targeted for a resale campaign;
c) a step wherein a customer owning an item of the same type as an item targeted for a resale campaign is selected from among the customers based on the owned item information; and
d) a step wherein the selected customer is given notice in the form of a message advising them with respect to resale of the owned item of the same type as an item targeted for a resale campaign.

18. A method for providing information according to claim 17 further having a step wherein reservation information in which there are recorded types of used items for which purchase is desired by customers is retained; and:
a) at the step in which the item is targeted for a resale campaign, the item is targeted for a resale campaign based on the types of used items recorded in the reservation information.

19. A product distribution system in which information processing is performed for resale of a used item, said product distribution system comprising:
a) owned item information retaining means that retains owned item information in which there is recorded information regarding items owned by customers;
b) item targeting means that targets an item for a resale campaign;
c) customer extraction means that selects a customer owning an item of the same type as an item targeted for a resale campaign from among the customers, based on the owned item information; and
d) notification means that gives notice to the selected customer in the form of a message advising them with respect to resale of the owned item of the same type as an item targeted for a resale campaign.

20. A product distribution system according to claim 19 further comprising reservation information retaining means that retains reservation information in which there are recorded types of used items for which purchase is desired by customers;
a) the item targeting means being such that the item is targeted for a resale campaign based on the types of used items recorded in the reservation information.
